(19) United States
(12) Patent Application Publication
(10) Pub. No.: US 2002/0140533 A1
(43) Pub. Date: Oct. 3, 2002

(54) Method of producing an integrated type microswitch

(76) Inventors: Masaru Miyazaki, Tokyo (JP); Yoshihide Miyagawa, Tokyo (JP); Takehisa Takoshima, Tokyo (JP)

Correspondence Address: GALLAGHER & LATHROP, 601 CALIFORNIA ST, SUITE 1111, SAN FRANCISCO, CA, 94108, US

(21) Appl. No.: 10/155,466

(22) Filed: May 23, 2002

Related U.S. Application Data
(62) Division of application No. 09/608,359, filed on Jun. 29, 2000.

(30) Foreign Application Priority Data
Jan. 12, 2000 (JP) 2000-003631
Jul. 1, 1999 (JP) 1999-187314

(51) Int. Cl. H01H 51/22

(52) U.S. Cl. 335/78

(57) ABSTRACT

An integrated type microswitch with high durability is provided. The integrated type microswitch is of the construction through micro-machining process in which a movable plate is provided above a fulcrum means movable in seesaw movement by means of either electrostatic or magnetic force, so that either one of movable contacts mounted on opposite free ends thereof is on-off connected to fixed contact disposed in opposite relation due to seesaw movement of the movable plate.

### FIELD OF THE INVENTION

This invention relates generally to an integrated type microswitch which may be produced by the use of the techniques of producing semiconductor integrated circuits and, more particularly, to an integrated type microswitch in which a movable plate is swingingly movably disposed on fulcrum means so that movable contacts mounted on the swing free end portions of the movable plate are alternately moved into and out of contact with corresponding fixed contacts formed on a substrate by means of electrostatic attraction force or electromagnetic attraction or repulsion force, and a method for producing the same.

### BACKGROUND OF THE INVENTION

With the enhanced functionalization of measuring instruments or various types of testing systems, high-performance miniature switches useful in applications ranging from direct current to high-frequency electric current have been used in large quantity. In addition, it is required that high-performance miniature switches be incorporated in circuit elements of integrated circuits handling signals upto microwaves or millimetric waves (which integrated circuits will be referred to as MMIC hereinafter).

Because of this requirement, silicon or gallium arsenide semiconductor FETs (field-effect transistors) or solid-state switch elements utilizing diodes have heretofore commonly been used. The solid-state switch element has the advantages that it provides high reliability due to being free from mechanically movable components and that the utilization of photolithographic technology allows for quantity production of switch components of miniature size having consistent characteristics.

On the other hand, however, such switch element has the disadvantage-that it brings a rather great insertion loss due to inability to adequately reduce the ON resistance when it is in the ON-state. Another disadvantage is that it has poor separation property due to inability to adequately reduce the electrostatic capacitance when it is in the OFF-state.

In this regard, such a type of switches as mechanical microswitches utilizing mechanical contact components has well recognized the advantages of reduced insertion loss as well as high separability. On this account, various methods of producing integrated type microswitches utilizing the technique of manufacturing semiconductor integrated circuits (micromachining technology) have been attempted.

### DESCRIPTION OF THE RELATED ART

FIGS. 49 and 50 illustrate the construction of a conventionally known integrated type microswitch as disclosed in, for example, “Micromechanical Membrane Switches on Silicon” by K. E. Petersen, IBM J. RES. DEVELOP. Vol. 23 No. 4, July 1979 pp376-385. In this FIGS. 49 and 50, upper and bottom electrodes are added for explanation purpose.

The conventional integrated type microswitch illustrated therein comprises a substrate 1 of semiconductor such as silicon having a recess 2 formed therein, a bottom electrode 3 formed on the bottom of the recess 2, a cantilever 4 formed in the top surface of the substrate and extending over the opening of the recess 2, and a top electrode 5 formed on the upper surface of the cantilever 4 at a position opposite to the bottom electrode, the arrangement being such that when a driving D.C. voltage is applied between the bottom electrode 3 and the top electrode 5 to generate electrostatic attraction, the free end of the cantilever 4 is moved toward the bottom of the recess 2 by the attraction to bring a movable contact 6 mounted on the free end of the cantilever 4 into contact with fixed contacts (signal lines) 7 and 8 to establish electrical continuity between the fixed contacts 7 and 8.

In addition, it is to be noted that the cantilever 4 may be formed by following steps of: forming a doped region (p+ region) 1A in a surface of the silicon substrate 1, which is doped with boron for vertical etch stop; forming a bottom electrode on the doped region; forming on the doped region as well as on the bottom electrode a silicon epitaxial layer 1B which is referred to as a sacrificial layer; forming a layer of material such as resin having an appropriate elasticity so as to span the upper surfaces of the sacrificial layer 1B; forming a generally U-shaped cutout groove 9 (see FIG. 49), and removing the sacrificial layer by supplying through the cutout groove 9 to the sacrificial layer a silicon etchant such as for example a hot (118° C.) solution of ethylene diamine pyrocatechol (EDP) to thereby form a recess 2 in the substrate. The hot solution of EDP can etch silicon at relatively high speed but hardly etch SiO2 as well as the doped region.

There is disclosed another conventional integrated type microswitch usable in up to high frequency range in The 8^{th} International Conference on Solid-State Sensors and Actuators, and Eurosensors IX “A Surface Micromachined Miniature Switch for Telecommunications Applications with Signal Frequencies from DC to 4 GHz,” pp 384-387, Jun. 25-29, 1995 by J. Jason Yao et al.,

Any of the conventional microswitch configurations as described above, is such that the cantilever 4 having the movable contact 6 mounted thereon is elastically deformed into contact with the fixed contacts 7 and 8 by means of electrostatic attraction force or electromagnetic attraction or repulsion force generated by application of a drive voltage between the upper and bottom electrodes. Consequently, there is a problem with the durability of the cantilever 4, so that accidents are likely to occur in which the fixed contacts 7 and 8 may continuously remain in the ON-state as a result of reduced restoring force or breakage of the cantilever 4.

In order to enhance the durability of the cantilever 4 it is conceivable to increase the thickness of the cantilever 4. If the thickness of the cantilever 4 is increased, however, it is accompanied by the trouble that a larger driving force for elastically deforming the cantilever 4 would be correspondingly required. There is an additional disadvantage that the pressure with which the movable contact 6 is forced into contact with the fixed contacts 7 and 8 is reduced, resulting in deteriorating the contact stability.

### SUMMARY OF THE INVENTION

While the integrated type microswitch manufactured by the micromachining technology has long posed the requirement that the stability be enhanced over a prolonged period in view of the fact that the metallic contacts are moved into and out of contact with each other by mechanical driving, though it has the advantage that such switches may be produced in quantity by the use of photolithographic technology and the advantage of reduced ON resistance and high separation loss. Such the advantages could be enjoyed, if the aforesaid requirement is satisfied.

Accordingly, it is an object of this invention to provide an improved integrated type microswitch which is designed to have less accidents of breakage of the movable components and which is capable of providing a firm on-off switching operation as well as providing increased contact pressure even with a relatively small attraction force.

According to this invention, a movable plate having a certain longitudinal length is mounted to the substrate by position-maintaining means in a position parallel to a substrate and movable in a seesaw movement about a pivot point at the midpoint position of the longitudinal length of the movable plate. A fulcrum means is formed vertically upwardly extending from the substrate below the midpoint position of the of the movable plate and has atop thereof a top ridge portion. The movable plate is formed by the use of semiconductor manufacturing technology in such a manner that the movable plate is mounted to the substrate by the position-maintaining means above the fulcrum means so that there is provided “in principle” a minimal gap between the top ridge portion of the fulcrum means and the movable plate positioned thereabove. The movable plate mounted to the substrate by the position-maintaining means is movable in a seesaw movement by means of attraction force (or repulsion force) generated between the substrate and either selected one of the opposite swing end portions of the movable plate located on the opposite sides of the fulcrum means while it is engaged with and supported by the fulcrum means at the midpoint thereof. The generation of the attraction (or repulsion) force is switched from between the selected one of the swing end portions and the substrate to between the other one of the swing end portions and the substrate, and vice versa.

In addition, movable contacts are disposed on the opposite swing end portions adjacent the respective free ends while fixed contacts are disposed on the substrate side in opposing relation to the corresponding movable contacts such that in response to the seesaw movement of the movable plate, the movable contacts are moved into and out of contact with the corresponding movable contacts to perform the switching function.

Here, the language “there is provided in principle a minimal gap” means that the movable plate is manufactured such that a minimal gap is present in terms of design, as will be appreciated by referring to the manufacturing methods as will be described hereinafter. In other words, the expression “in principle” is intended to mean that in the finished product, the movable plate can possibly assume a position in which it is in touch with the top ridge portion of the fulcrum means, depending on the weight of the movable plate.

In the present invention, the contact configuration is capable of various desired modifications including not only the configuration for making and breaking continuity between a movable contact and a fixed contact, but also the configuration for making and breaking continuity between a plurality of fixed contacts by a movable contact.

The means for providing driving force to the movable plate for its seesaw movement may also take various forms.

The integrated type microswitch as claimed in claim 1 of the present application comprises:

fulcrum means upstanding from one side surface of a substrate;

a movable plate supported by the fulcrum means for seesaw movement;

drive means for generating attraction force (or repulsion force) between the substrate and one of the opposite swing end portions of the movable plate located on the opposite sides of the fulcrum means;

movable contacts mounted on the opposite free ends of the movable plate; and

fixed contacts adapted to be electrically connected to and disconnected from the movable contacts by means of the seesaw movement of the movable plate.

The integrated type microswitch as claimed in claims 2-9 are directed to variations in the drive means of the integrated type microswitch as claimed in claim 1.

Claim 2 is directed to the drive means which is constructed of two lower electrodes formed on the substrate and the movable plate made of conductive material. With a positive potential of a D.C. driving source, for example, is applied to the movable plate, while a negative potential is applied alternatively to one and the other of the two lower electrodes, so that the movable plate is caused to be moved in a seesaw movement by means of electrostatic force whereby the movable contacts electrically connect and disconnect with the fixed contacts.

In claim 3, the movable plate is made of insulator and has upper electrodes formed on the opposite swing end portions thereof located on the opposite sides of the fulcrum means while lower electrodes are formed on the substrate at positions symmetrical about the fulcrum means in opposing relation to the corresponding upper electrodes. Applying a driving voltage between the upper electrodes and the lower electrodes will move the movable plate in a seesaw movement to thereby cause the movable contacts electrically connect and disconnect to the fixed contacts.

Claim 4 discloses an electrostatically driven integrated type microswitch in which a plurality of lower electrodes are formed on the substrate in opposing relation to each of the opposite swing end portions of the movable plate so that a plurality of electrostatic capacitances are provided between the plurality of lower electrodes and each of the opposite swing end portions of the movable plate, the arrangement being such that when a driving potential is applied between the plurality of lower electrodes corresponding to either one of the opposite swing end portions of the movable plate, electric charge will be accumulated in the respective electrostatic capacitances to generate electrostatic attraction forces between the substrate and the one of the opposite swing end portions.

The integrated type microswitch as disclosed in claim 5 is characterized by the drive means comprising planar coils formed on the movable plate at positions symmetrical about the pivot point thereof and permanent magnet means adapted to generate magnetic fields parallel to magnetic fields generated by the planar coils to thereby attractive magnetic forces.

The use of permanent magnets as magnetic field generating means allows for providing substantial attraction and repulsion even if the magnetic fields generated by the planar coils are minimal, resulting in providing an integrated type microswitch ensuring a stable state of contact between the fixed contacts and the movable contacts.

The integrated type microswitch as disclosed in claim 6 is characterized by the drive means comprising the movable plate constructed of magnetic material and exciting coils consisting of wire wound in a tubular form and mounted in the substrate. Winding wire in a tubular form allows for increasing the number wire turns, contributing to providing intensified magnetic attraction or repulsion force. Consequently, this construction again provides an integrated type microswitch ensuring a stable state of contact between the fixed contacts and the movable contacts.

The integrated type microswitch as disclosed in claim 7 is characterized by the drive means including exciting coils consisting of wire wound in a tubular form in which the exciting coils are supported by a supplemental substrate mounted above the movable plate so that attraction force is provided from above the movable plate.

The integrated type microswitch as disclosed in claim 8 is characterized by the drive means comprising magnetic attraction pieces of magnetic material mounted on the movable plate which is made of non-magnetic material, and exciting coils embedded in the substrate, so that the magnetic attraction pieces may produce attraction force in conjunction with magnetic fields generated from the exciting coils.

While the magnetic attraction pieces set forth in claim 8 is characterized in that they are simply made of magnetic material, claim 9 is directed to the drive means further characterized in that the magnetic attraction pieces are magnetized with the opposite polarities along the direction of their thickness so that a contact pressure of increased strength (to act between the movable contacts and the fixed contacts) may be provided by synergistic effects between the magnetic fields of the magnetic attraction pieces and those of the exciting coils.

Claims 10 and 11 of this application are directed to the position-maintaining means for maintaining the movable plate in position.

Claim 10 proposes the position-maintaining means which comprises support plates upwardly raised from the planar surface of the substrate and elastically deformable hinge means integrally formed with the movable plate and connecting the opposite sides of the movable plate at the pivot point with the support plates. The hinge means allows the movable plate to move the seesaw movement and yet prevents the displacement in position of the movable plate above the fulcrum means.

Claim 11 proposes the position-maintaining means which comprises a pair of support shafts extending from the opposite sides of the movable plate at the pivot point perpendicularly to the longitudinal length of the movable plate and a pair of bearing means for receiving the support shafts therethrough. The bearing means are formed on the support plates which are in turn protruded from the planar surface of the substrate.

Claims 12-17 of this application are directed to the construction of the fixed contacts and the movable contacts.

Claim 12 proposes an integrated type microswitch in which the movable contacts are formed by deposition on the underside of the movable plate at the free ends of the opposite swing end portions thereof and terminating in outer ends extending beyond the free ends of the movable plate while the fixed contacts are formed on the planar surface of the substrate, the arrangement being such that the fixed contacts are electrically connected to and disconnected from each other by means of the movable contacts.

Claim 13 proposes the integrated type microswitch in which the movable contacts are provided with resiliency allowing for elastic deformation, which movable contacts with resiliency act to provide self-cleaning action between the movable contacts and the fixed contacts.

Claim 14 proposes the integrated type microswitch in which movable contacts are formed on the upper side of the movable plate adjacent the free ends of the opposite swing end portions thereof while fixed contacts are attached to respective beams mounted at an elevation spaced upwardly from the planar surface of the substrate.

Claim 15 proposes the integrated type microswitch in which fixed contacts are constructed of conductors comprising signal transmission lines matched at a predetermined impedance.

Claim 16 is directed to the limitation on the construction of the signal transmission lines matched at a predetermined impedance that are specifically composed of microstrip lines.

Claim 17 proposes the integrated type microswitch in which fixed contacts are constructed of coplanar microstrip lines.

It will be appreciated that the integrated type microswitch as claimed in claims 15-17 introduces the advantage of providing for on-off controlling even high-frequency signals without deteriorating the waveform quality, due to the fixed contacts being constructed of impedance-matched signal transmission lines.

Claim 18 proposes an integrated type microswitch comprising:

fixed contacts formed on one side surface of a substrate;

a cantilever fixed at one end relative to the substrate and having the other pivotable free end located in opposition to a fixed contact, the cantilever being formed of conductor; and

an exciting coil located in opposition to the pivotable free end of the cantilever, the coil being composed of wire wound in a tubular form.

Claim 19 proposes an integrated type microswitch comprising:

a movable plate supported in a cantilever fashion on one side surface of a substrate, the movable plate being formed of a magnetic material having conductivity;

a fixed-contact supporting cantilever formed of nonmagnetic conductor, the cantilever supporting thereon a fixed contact at a position in opposition to, but slightly spaced from the pivotable free end of the movable plate; and

an exciting coil located in opposition to the pivotable free end of the cantilever, the coil being composed of wire wound in the form of a tube.

According to the invention as claimed in claim 20, an integrated type microswitch is provided in which a movable plate of polygonal shape, for example a rectangular shape, is supported on its center by fulcrum means upstanding from a substrate. A lower electrode is formed on the underside of the substrate in opposition to the movable plate. Movable contacts are formed on the undersurface of the movable plate one at each of the four corners thereof while on the upper side of the movable plate, triangular upper electrodes are formed one at each of the four corners thereof. The arrangement is such that when a driving voltage is applied between any one of the upper electrodes and the lower electrode, one corner portion of the movable plate is moved toward the substrate to thereby move the associated one of the movable contacts into on-contact with the corresponding fixed contact while the others are off-contacts with the corresponding fixed contacts.

While the fulcrum means as set forth in the claims referred to so far is illustrated as having a top ridge portion, the fulcrum means in this claim 20 is designed to have a top ridge of a conical shape having a minimal ‘ridge’ (horizontal) length but it may of course have any appropriate shape depending on the polygonal shape.

Claim 21 proposes an integrated type microswitch comprising a plurality of integrated type microswitches formed on a common substrate and combined in a monolithic unit.

Claim 22 is directed to an integrated type microswitch which is housed in a sealed enclosure which is then filled with inert gas.

Claims 23-27 propose methods of producing the various integrated type microswitches as described above.

Claim 23 is directed to the manufacturing method as illustrated in FIG. 5.

Claim 24 teaches a method of producing the integrated type microswitch of the construction as illustrated in FIGS. 25-28 in which bearing means is employed as the position-maintaining means.

Claim 25 proposes a method of producing the integrated type microswitch equipped with elastically deformable movable contacts as illustrated in FIG. 17.

Claim 26 proposes a method of producing the integrated type microswitch equipped with planar coils as illustrated in FIGS. 30-32.

Claim 27 is directed to a method of producing the integrated type microswitch equipped with exciting coils as illustrated in FIGS. 38 and 39.

Claim 28 is directed to an integrated type microswitch in which a method for forming a minimal gap is defined.

Claim 29 is directed to an integrated type microswitch in which movable contacts and fixed contacts are maintained in off-state while the movable plate is in inactive.

As discussed above, in the integrated type microswitch according to this invention, the movable plate is caused to be moved in a seesaw movement by attraction force or repulsion force generated by either static or magnetic electricity to thereby cause the movable contacts disposed on the swing ends of the movable plate to electrically connect and disconnect with the fixed contacts. It will thus be appreciated that the integrated type microswitch of this invention is capable of providing switching function of good quality with reduced ON resistance during the conduction state and high OFF resistance upon opening state.

In addition, due to the micro-structure which is realized by micromachining techniques such as photolithography technology, the integrated type microswitch according to this invention provides for speeding up the movement of the movable contacts, leading to the advantage of providing fast-response, integrated type microswitches.

Moreover, the micro-structure of the integrated type microswitch according to this invention allows for mounting an increased number of switches in a limited space, so that even a complicated switching circuit may be integrated in such a small configuration as a semiconductor device. Accordingly, it is expected that the application ranges or fields of usage of the integrated type microswitch of this invention will be widened.

### BRIEF DESCRIPTION OF THE DRAWINGS

FIG. 1 is a plan view illustrating a first embodiment of the integrated type microswitch as claimed in claim 1 or 2;

FIG. 2 is a cross-sectional view taken on line 2-2 of FIG. 1;

FIG. 3 is a perspective view illustrating the general construction of the integrated type microswitch shown in FIGS. 1 and 2;

FIG. 4 is an electrically equivalent circuit diagram of the integrated type microswitch shown in FIGS. 1 and 2;

FIG. 5 is diagrammatic views illustrating sequential steps of a process for manufacturing the integrated type microswitch shown in FIGS. 1 and 2;

FIG. 6 is a plan view illustrating a second embodiment which is a modification of the integrated type microswitch as shown in FIGS. 1 and 2;

FIG. 7 is a cross-sectional view taken on line 7-7 of FIG. 6;

FIG. 8 is an electrically equivalent circuit diagram of the integrated type microswitch shown in FIGS. 6 and 7;

FIG. 9 is a plan view illustrating a third embodiment which is another modification of the integrated type microswitch as shown in FIGS. 1 and 2;

FIG. 10 is a cross-sectional view taken on line 10-10 of FIG. 9;

FIG. 11 is an electrically equivalent circuit diagram of the integrated type microswitch shown in FIGS. 9 and 10;

FIG. 12 is a plan view illustrating a fourth embodiment which is still another modification of the integrated type microswitch as shown in FIGS. 1 and 2;

FIG. 13 is a cross-sectional view taken on line 13-13 of FIG. 12;

FIG. 14 is a plan view illustrating a fifth embodiment of the integrated type microswitch as claimed in claim 3;

FIG. 15 is a cross-sectional view taken on line 15-15 of FIG. 14;

FIG. 16 is a cross-sectional view illustrating a sixth embodiment which is a modification of the integrated type microswitch as shown in FIG. 14;

FIG. 17 is diagrammatic views illustrating sequential steps of a process for manufacturing the integrated type microswitch shown in FIGS. 14 and 15;

FIG. 18 is a cross-sectional view illustrating a seventh embodiment which is a modification of the integrated type microswitch as shown in FIG. 14;

FIG. 19 is a cross-sectional view illustrating a eighth embodiment which is another modification of the integrated type microswitch as shown in FIG. 14;

FIG. 20 is a plan view illustrating a ninth embodiment of the integrated type microswitch as claimed in claim 4;

FIG. 21 is a cross-sectional view taken on line 21-21 of FIG. 20;

FIG. 22 is a plan view illustrating a tenth embodiment of the integrated type microswitch as claimed in claim 11;

FIG. 23 is a cross-sectional view taken on line 23-23 of FIG. 22;

FIG. 24 is a plan view illustrating an eleventh embodiment which is a combination of the embodiment shown in FIG. 22 and the embodiment shown in FIG. 20;

FIG. 25 is cross-sectional views illustrating sequential steps of a process for manufacturing the integrated type microswitch shown in FIG. 22;

FIG. 26 is cross-sectional views illustrating sequential steps continued from the steps of the process shown in FIG. 25;

FIG. 27 is cross-sectional views illustrating sequential steps further continued from the steps of the process shown in FIGS. 25 and 26;

FIG. 28 is a plan view supplementarily illustrating the step shown in FIG. 26A;

FIG. 29 is a plan view supplementarily illustrating the step shown in FIG. 26A;

FIG. 30 is a plan view illustrating a twelfth embodiment of the integrated type microswitch as claimed in claim 5;

FIG. 31 is a cross-sectional view taken on line 31-31 of FIG. 30;

FIG. 32 is a plan view illustrating a thirteenth embodiment which is a modification of the embodiment shown in FIG. 30;

FIG. 33 is a plan view illustrating a fourteenth embodiment of a perspective view illustrating as claimed in claim 6;

FIG. 34 is a cross-sectional view as taken from the side of FIG. 30;

FIG. 35 is diagrammatic views illustrating sequential steps of a process for manufacturing the integrated type microswitch shown in FIGS. 33 and 34;

FIG. 36 is a perspective view illustrating an example of the exciting coil used in the integrated type microswitch shown in FIGS. 33 and 34;

FIG. 37 is a plan view illustrating the exciting coil shown in FIG. 36 mounted in a bore formed in the substrate;

FIG. 38 is a plan view illustrating a fifteenth embodiment which is a modification of the integrated type microswitch as shown in FIGS. 33 and 34;

FIG. 39 is a cross-sectional view illustrating the construction of the integrated type microswitch shown in FIG. 38;

FIG. 40 is a cross-sectional view illustrating a sixteenth embodiment of the integrated type microswitch as claimed in claim 18;

FIG. 41 is a cross-sectional view illustrating a seventeenth embodiment of the integrated type microswitch as claimed in claim 19;

FIG. 42 is a plan view illustrating an eighteenth embodiment which is another modification of the integrated type mircoswitch as shown in FIGS. 33 and 34;

FIG. 43 is a plan view as viewed from the top of FIG. 42;

FIG. 44 is a plan view illustrating a nineteenth embodiment of the integrated type microswitch as claimed in claim 1;

FIG. 45 is an electrically equivalent circuit diagram of the switch shown in FIG. 33;

FIG. 46 is a plan view illustrating a 20th embodiment of this invention;

FIG. 47 is a cross-sectional view illustrating a 21th embodiment of this invention;

FIG. 48 is a perspective view illustrating a 22th embodiment of this invention;

FIG. 49 is a perspective view illustrating the prior art; and

FIG. 50 is a cross-sectional view taken on line 50-50 of FIG. 49.

### DESCRIPTION OF THE PREFERRED EMBODIMENTS

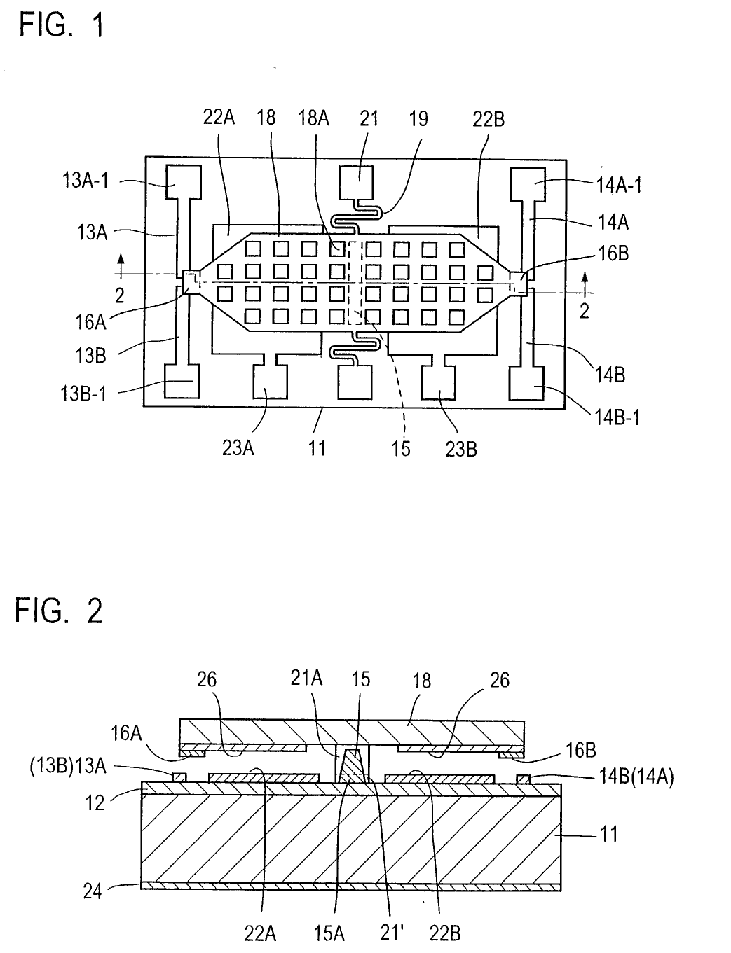

FIGS. 1 through 4 illustrate a first embodiment of the integrated type microswitch of this invention as set forth in claims 1, 2, 10 and 12 in which 11 indicates a substrate made of semiconductor such as for example silicon (Si) or gallium arsenide (GaAs).

The integrated type microswitch of this embodiment is configured to electrically open and close between the mutually separated fixed contacts 13A and 13B, and 14A and 14B, respectively, which are disposed on an insulation layer 12 overlaid on the substrate 11 by means of the movable contacts 16A and 16B formed on a movable plate 18.

The movable contacts 16A and 16B are formed downwardly on an insulation layer 26 which is formed underneath the electrically conductive movable plate 18. (FIG. 2).

The movable plate 18 has a pair of position-maintaining means 19 extending from its opposite lateral sides in the center between its opposite ends perpendicularly (in vertical direction as viewed in FIG. 1) to the longitudinal length of the movable plate (the right-to-left direction as viewed in FIG. 1). Vertically upstanding from the upper surface of the substrate 11 toward the center of the movable plate 18 is a fulcrum means 15 which acts as means for allowing the movable plate 18 to have seesaw movement. The position-maintaining means 19 is integrally formed with the movable plate 18. The movable plate 18 is made of such as for example a multi-layer film comprising an underlayer of polysilicon and an upper layer of electrically conductive material such as aluminum and serves to maintain the position of the movable plate 18 relative to the substrate 11. The illustrated embodiment shows an instance in which the position-maintaining means 19 comprises elastically deformable hinges. The pair of position-maintaining means 19 have a pair of electrode sections 21 at outer terminal ends thereof, which are electrically and mechanically bonded onto support plates 21A which are formed on the insulation layer 12 so as to be raised from the substrate like the fulcrum means which sections may be composed of metallic plating layers for example. The position-maintaining means 19 is preferably made as long as possible, and in the example shown in FIG. 1 it is formed in a serpentine form so as to facilitate elastically deformation. It is thus to be appreciated that the position-maintaining means 19 serves to support the movable plate 18 without being misaligned over the fulcrum means 15 and yet maintains it in a manner such that it is capable of seesaw motion about the fulcrum means when the plate is engaged with the beam. It should be noted that the position-maintaining means 19 need not apply resilient biasing force to the movable plate 18 but only need to prevent displacement of the movable plate 18 from proper position. Consequently, the position-maintaining means 19 may be formed in the form of a narrow strip or thin wire, requiring only a little strength.

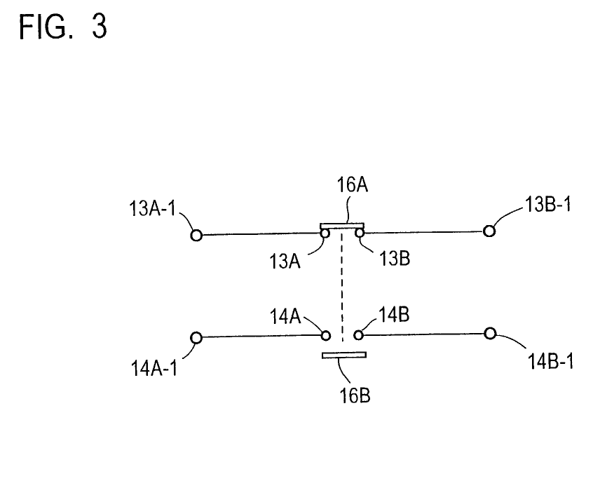

Disposed on the insulation layer 12 of the substrate 11 in opposing relation to the undersurface of the movable plate 18 are lower electrodes 22A and 22B. The electrodes 22A and 22B are positioned symmetrically about the fulcrum means 15 and is adapted to be selectively supplied with a driving voltage from their terminal portions 23A and 23B. Upon a driving voltage being applied to the movable plate 18 and one of the lower electrodes, the electrode 22A for instance, electrostatic attraction force is generated, so that the movable contact 16A formed on the swing end of the movable plate 18 is moved into contact with the fixed contacts 13A and 13B. Hence, electrical continuity is established between the terminals 13A-1 and 13B-1. Conversely, when a driving voltage is applied to the movable plate 18 and the other lower electrode 22B, then attraction is exerted on the other swing end of the movable plate 18, so that the other movable contact 16B is moved into contact with the fixed contacts 14A and 14B. Hence in this case, electrical conduction is made between the terminals 14A-1 and 14B-1. FIG. 3 diagrammatically illustrates an electrically equivalent circuit of the integrated type microswitch shown in FIGS. 1 and 2.

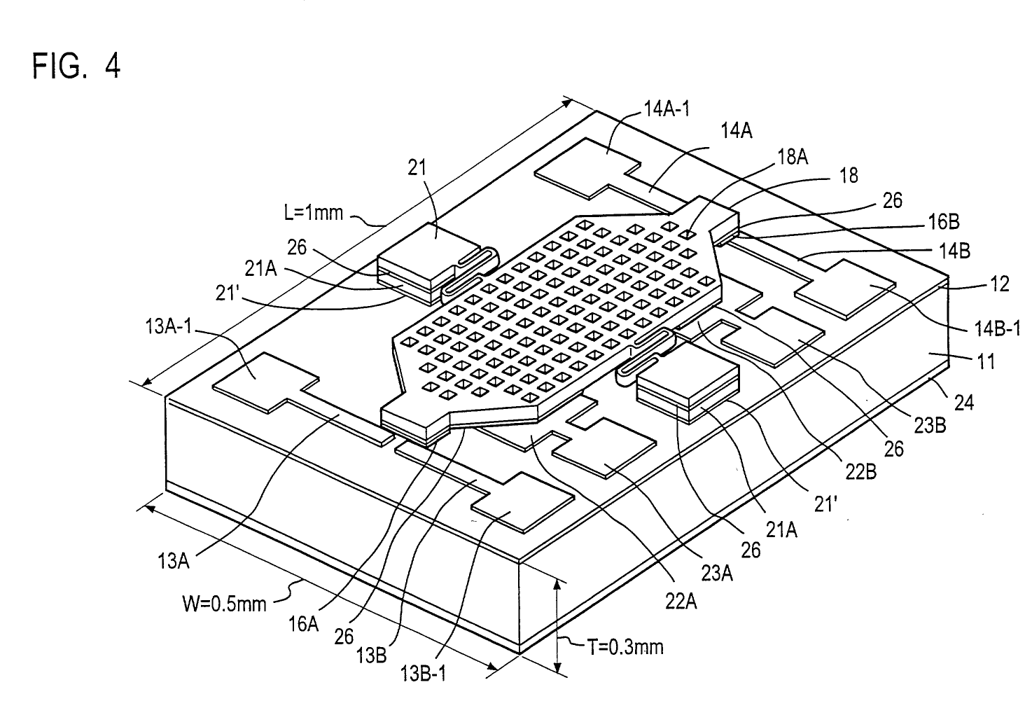

It should also be noted that this embodiment shows an instance in which the fixed contacts as recited in claim 15 are composed of conductors comprising an impedance-matched signal transmission line. More specifically, in this example the fixed contacts 13A, 13B and 14A, 14B constitute a microstrip line by means of a common potential layer 24 formed on the back side of the substrate 11. Accordingly, the fixed contacts 13A, 13B and 14A, 14B may be employed as a high-frequency transmission line for the on-off control of high-frequency signals. It is also seen in FIGS. 1 and 4 that the movable plate 18 is formed with a multiplicity of through-apertures 18A which are used in a manufacturing method as will be described with reference to FIG. 5. The method of producing the integrated type microswitch according to this invention will now be described by referring to FIG. 5.

An insulation layer 12 such as SiO₂ is formed on the top surface of a substrate 11 of semiconductor such as silicon or gallium arsenide. Then, a common potential layer 24 of metallic film for constituting a microstrip line is formed on the back side of the substrate 11 (FIG. 5A).

The next step is to deposit a metallic film (such as Rh, Zr) on the upper surface of the insulation layer 12 as by sputtering, followed by forming fixed contacts 13A, 13B, 14A, 14B, terminals 13A-1, 13B-1, 14A-1, 14B-1, lower electrodes 22A, 22B, terminals 23A, 23B, a base 15′ for the fulcrum means, and bases 21′ for support plates 21A in the metallic film by appropriate masking and etching processes. Further, a fulcrum means 15 of a predetermined height and support plates 21A (on which electrode sections 21 will finally be formed) are formed on the base 15′ and the bases 21′, respectively as by Ni-plating (FIG. 5B).

It is noted that the fulcrum means 15 has a top ridge portion 15B as shown in FIG. 5C.

Next, a layer 25 of resin such as polyimide is formed on the surface of the substrate having the fixed contacts 13A, 13B, 14A, 14B, lower electrodes 22A, 22B, the fulcrum means 15, the support plates 21A and the others formed thereon. The resin layer 25 is formed to have a thickness slightly greater than the height of the fulcrum means 15 and the support plates 21A, and is then partially removed by etching to an extent that the fulcrum means 15 and the support plates 21A are exposed, to thereby form a flat surface 25A. Further, on this flat surface 25A, a film of conductive metal (such as Rh) which will be ultimately the movable contacts 16A, 16B is formed, followed by forming the movable contacts 16A, 16B by masking and etching processes (FIG. 5C).

Then resin is further added on the flat surface so as to have another flat surface 25B which is coplanar to the movable contacts. (FIG. 5D) In the next step, an insulation layer 26 (such as SiO₂) which will serve to define the height of a gap between the fulcrum means and the movable plate is formed to cover the entire surface 25B of the resin layer 25, and on top of that insulation layer 26 an underlayer 18C of polysilicon or the like is formed to a thickness adequately great as compared with the film thickness of the insulation layer 26 and then an upper layer 18D of aluminum (Al) is laminated on the underlayer by sputtering, which laminated layers 18C and 18D are to be a movable plate 18. The movable plate 18 will act as a conductive plate due to the existence of the conductive aluminum layer 18D.

Subsequently, a photoresist, for example is applied on the upper surface of the conductive layer 18D, followed by forming a photoresist pattern in conformity to the shapes of the movable plate 18 and those portions which will ultimately be the position-maintaining means 19 and the electrode sections 21, whereafter those portions of the conductive layer 18D having the photoresist removed are eliminated by wet etching or ion milling process to form shapes of the movable plate 18, the position-maintaining means 19 and the electrode sections 21. It should be noted that during this etching process, through-apertures 18A are also formed through that portion of the conductive layer 18D and the under layer 18C at a area which is to be the movable plate 18. (FIG. 4) Once the movable plate 18, the position-maintaining means 19 and the electrode sections 21 have been formed, those exposed portions of the insulation layer 26 through the through-apertures and uncovered by the movable plate 18, the position-maintaining means 19 and the electrode sections 21 are removed. (FIG. 5D)

A mask M1 is laid over those portions of the insulation layer 26 other than the central portion 18E (corresponding to the top ridge portion 15′ of the fulcrum means 15 and its surrounding portions) as shown in FIG. 5E, and then the insulation layer 26 is etched off through the through-apertures 18A formed in the movable plate 18 as by wet etching or dry etching to define a gap G1 between the top ridge 15′ of the fulcrum means 15 and the movable plate 18. (FIG. 5E)

After that, the mask M1 is removed, and with the movable plate 18, the position-maintaining means 19 and the electrode sections 21 acting as masks, only the resin layer 25 is etched off to define a void space G2 between the movable plate 18 and the substrate 11. (FIG. 5F) During the removal of the insulation layer 26, the portions of the insulation layer underneath the electrode sections 21 are remained so that the electrode sections 21 are remained to be secured to the support plates 21A, thus the movable plate is supported on the substrate.

An integrated type microswitch as illustrated in FIGS. 1-4 is now completed with the formation of the void space G2. It is thus to be appreciated that the integrated type microswitch may be made by the technique of producing semiconductor integrated circuits, so that a multiplicity of integrated type microswitches may be produced in a batch in an extremely small size as a whole on a common substrate. By way of example, the substrate 11 cut in the form of a chip will have dimensions on the order of 0.5 mm in width W, 1.0 mm in length L and 0.3 mm in thickness T. For information, the resin layer 25 used to form the void space G2, and the insulation layer 26 used to form the gap G1 are called as sacrificial layers.

It should be understood here that the dimensions of the various components shown in FIGS. 1-5 are exaggerated for the benefit of understanding of the invention, but not represent the actual size. This is also the case with the following drawings.

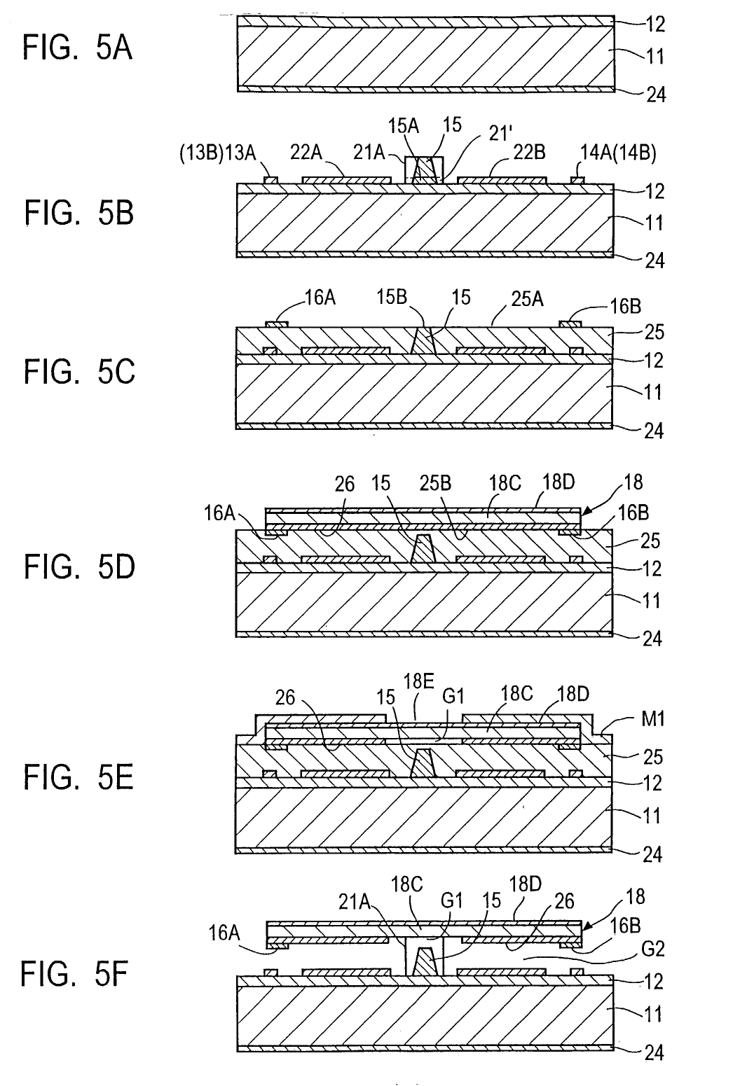

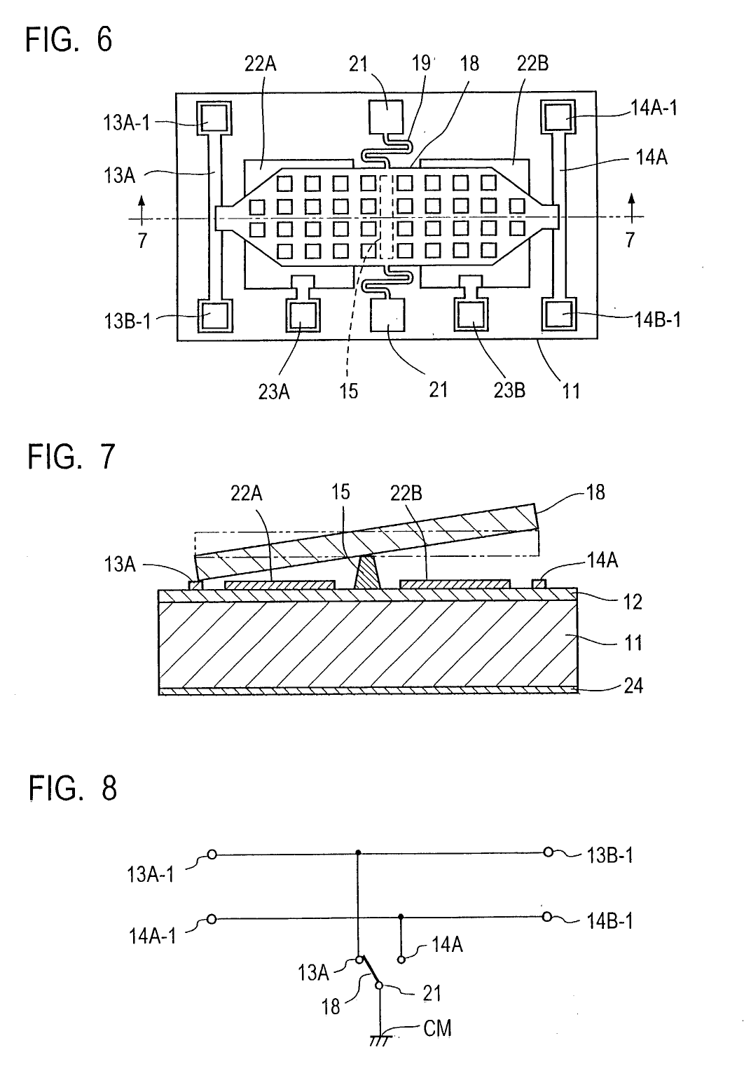

FIGS. 6 and 7 illustrate a second modified embodiment of the integrated type microswitch of this invention as set forth in claims 1 and 2. This embodiment shows an instance in which an integrated type microswitch having a circuit structure as illustrated in FIG. 8 is constructed. In FIGS. 6-8, corresponding reference numerals are used for those components which correspond to the components in FIGS. 1-5.

Specifically, in this embodiment the fixed contacts 13A and 14A comprise continuous signal lines as seen in FIG. 6 and the movable plate 18 is made of electrical conductor and is connected through the electrode sections 21 with a common potential point CM (FIG. 8), so that the switching operation may be performed such that upon contacting the movable plate 18 with the fixed contact 13A, the fixed contact 13A is in turn connected with the common potential point CM to interrupt the signal transmission from the terminal 13A-1 to the terminal 13B-1, and that conversely, when the movable plate 18 is contacted with the fixed contact 14A, the fixed contact 14A is in turn connected with the common potential point CM to interrupt the signal transmission from the terminal 14A-1 to the terminal 14B-1.

This movable plate 18 is formed of a multi-layer film of metals. To this end, in the manufacturing process illustrated in FIGS. 5A to 5F, once the resin layer 25 has been formed as shown in FIG. 5D, a metallic multi-layer film is formed by depositing Ti, Pd and Au sequentially in the order named on the entire surface 25D of the resin layer 25 by sputtering, followed by further forming a Ni alloy-plating for example to a thickness of about 20 μm on the multi-layer film. This thick Ni alloy-plating layer is then coated with a photoresist to form a photoresist pattern. With this photoresist pattern as a mask, the unnecessary portions of the metallic layer composed of Ti, Pd, Au and Ni are removed as by ion milling to form the movable plate 18, hinges 19 and electrodes 21. It is to be understood that the movable contacts on the movable plate 18 may be of a capacitor structure comprising a metal for conducting alternating current and an insulation film. It should also be noted that during this etching process, through-apertures 18A are formed through that portion of the multi-layer at an area which is to be the movable plate 18.

Since the Ti layer may be easily removed by HF-based chemical etchant, a mask M1 is laid over those portions of the multi-layer other than the central portion 18E (corresponding to the top ridge portion of the fulcrum means and its surrounding portions), and then that portion of the Ti layer present in this central portion 18E is etched off through the through-apertures 18A formed in the movable plate 18 to separate the fulcrum means 15 and the movable plate 18 from each other. A gap gi corresponding to the film thickness of the Ti layer is thus defined between the fulcrum means 15 and the movable plate 18. In addition, since it is preferable that the contact sections on the movable plate 18 be formed of Pd, those portions of the Ti layer corresponding to the contact sections are also removed. It is also to be understood that a resin layer such as photoresist may be placed as a sacrificial layer between the fulcrum means 15 and the movable plate 18, if desired.

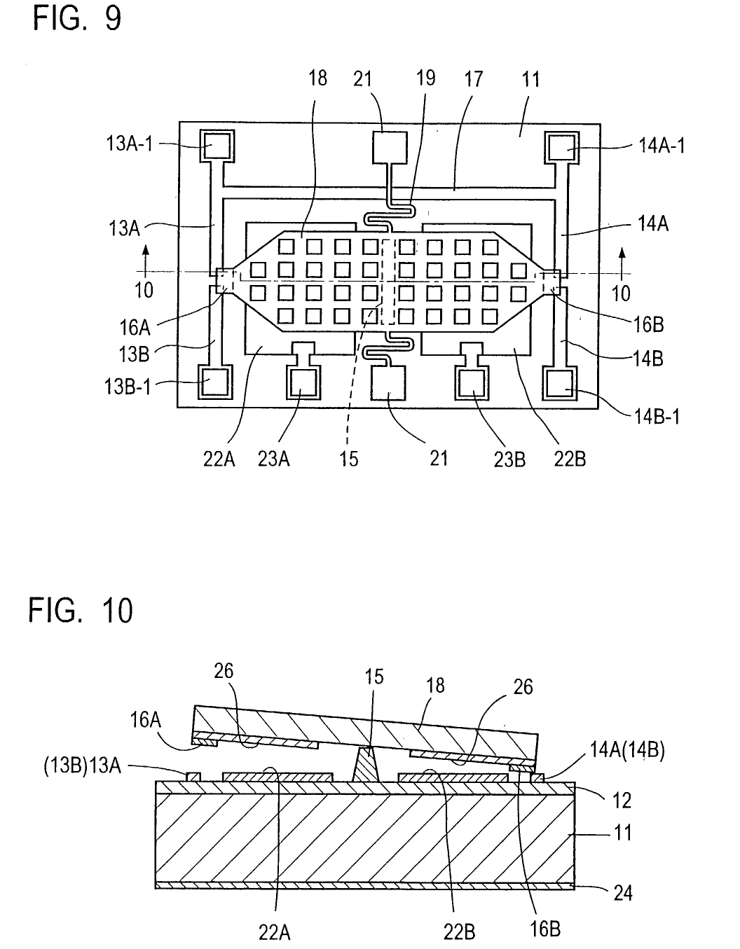

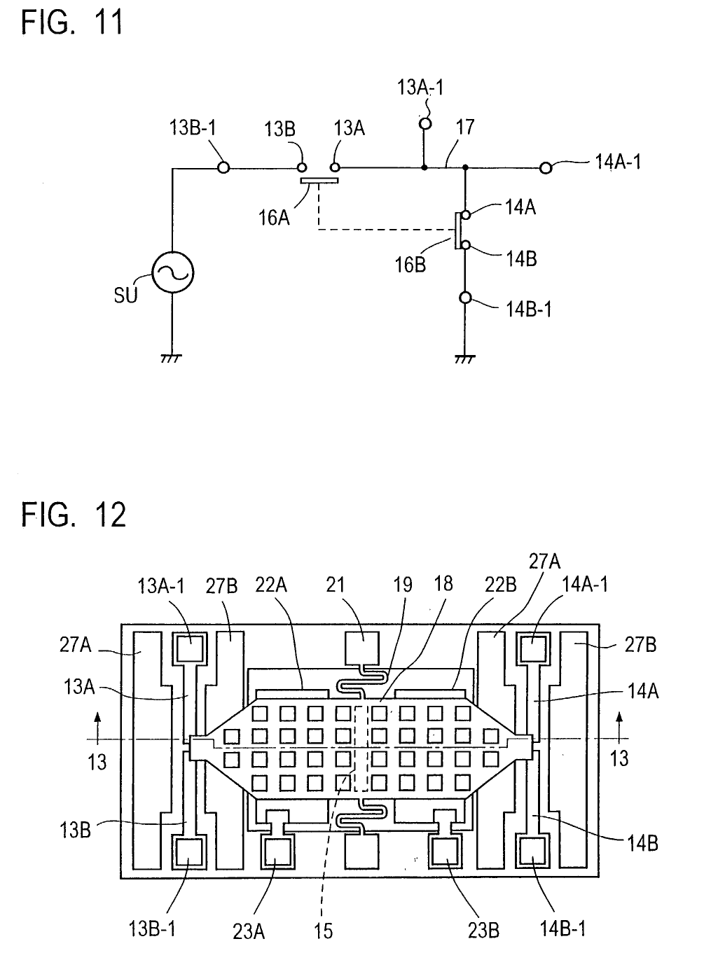

FIGS. 9-11 illustrate a third embodiment of the integrated type microswitch of this invention as set forth in claims 1 and 2. This embodiment shows the construction of an integrated type microswitch suitable to constitute a switching circuit as illustrated in FIG. 11. Specifically, in this switching circuit, a signal source SU is connected with the terminal 13B-1 so that the switching operation may be performed between one position in which a signal is taken out of the signal source SU and the other position in which such signal transmission is interrupted. Further, it is noted in this circuit that the terminal 14B-1 is connected with a common potential point CM so that in the position in which the signal transmission is interrupted, the terminal 14A-1 is connected through the movable contact 16B with the common potential point CM to prevent any leakage of the signal from the signal source SU to the terminal 14A-1.

To this end, the fixed contacts 13A and 14A are connected by wiring conductor 17 (FIG. 9) such that the seesaw movement of the movable plate 18 alternately switches the fixed contacts 13A and 13B on one hand and the fixed contacts 14A and 14B on the other hand between the on (or off) position and the off (or on) position, whereby the signal from the signal source SU may be switched between the ON-state for output to the terminal 14A-1 and the OFF-state for interruption of the signal.

The embodiment illustrated in FIGS. 9-11 is multi-featured or enhanced in function by the provision of the wiring conductor 17, and such integrated type microswitch may still be produced by the same manufacturing process as that described with reference to FIGS. 5A to 5F. It will also be appreciated that other elements such as resistors and capacitors may likewise be mounted on the same single substrate and integrated to complete a switch.

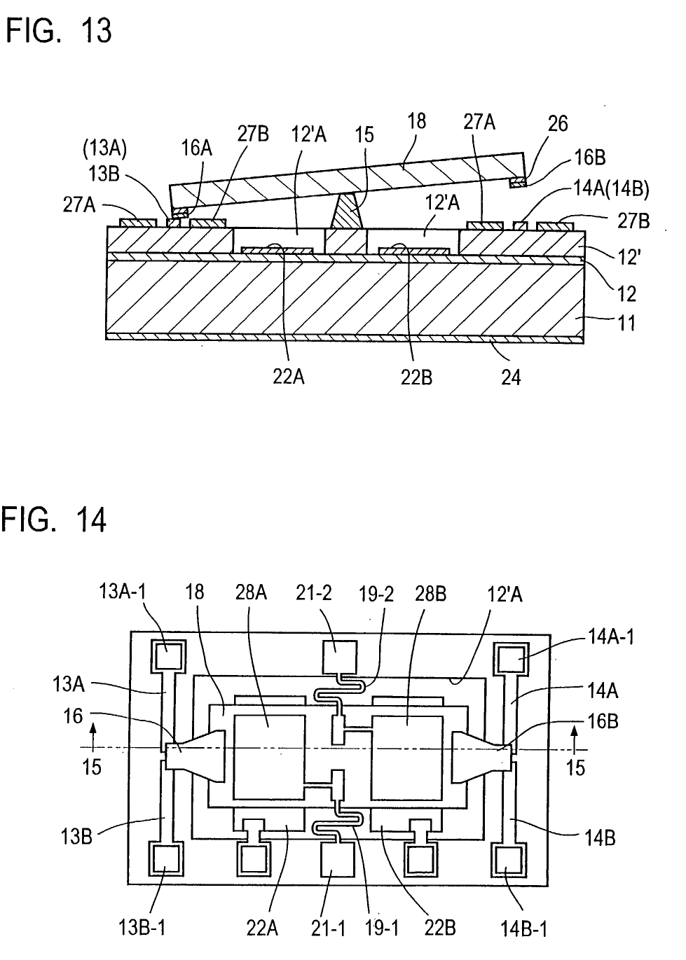

FIGS. 12 and 13 illustrate a fourth embodiment of the integrated type microswitch of this invention as set forth in claims 15-17 in which the fixed contacts comprises signal transmission lines impedance-matched at a predetermined impedance. Specifically, this embodiment shows an instance in which the fixed contacts 3A, 13B and 14A, 14B are composed of coplanar type signal transmission lines which is one type of the strip line. More specifically, conductors 27A and 27B having a common potential may be arranged on the opposite sides of the fixed contacts 3A, 13B and 14A, 14B, respectively to define coplanar type signal transmission lines. In this case, there need not necessarily be the common potential layer 24 deposited on the back side of the substrate 11.

Further, in this embodiment, the coplanar type microstrip lines are illustrated as being produced by forming an additional thicker insulation layer 12′ (FIG. 13) on the insulation layer 12 and forming the fixed contacts 3A, 13B and 14A, 14B and the common potential conductors 27A and 27B on the additional insulation layer 12′.

In addition, it is to be noted in this embodiment that the fulcrum means 15 is formed on this additional insulation layer 12′ while the lower electrodes 22A, 22B are formed on those portions of the insulation layer 12 exposed by forming recesses 12′A in the insulation layer 12′.

FIGS. 14-16 illustrate a modified form of the integrated type microswitch of this invention provided with upper electrodes 28A, 28B as set forth in claim 3, and fifth and sixth embodiments of the integrated type microswitch of this invention as set forth in claim 13 in which the movable contacts 16A and 16B are configured so as to allow elastic deformation. In these embodiments, the upper electrodes 28A, 28B are formed on the upper surface of the movable plate 18 such that attraction forces may be generated between the upper electrodes 28A, 28B and the respective lower electrodes 22A, 22B to swing the movable plate 18 in both directions in a seesaw fashion by supplying the upper electrodes 28A and 28B separately with driving voltage through the respective the electrode sections 21-1, 21-2 and the hinges 19-1, 19-2. While in FIG. 14 the movable plate 18 is shown as having no through-apertures 18A, a number of the through-apertures 18A are actually formed through the movable plate 18.

In addition, these embodiments are characterized by the movable contacts 16A and 16B are formed as free end portions protruding longitudinally (in the right-to-left direction as viewed in the drawings) from the movable plate 18 adjacent its opposite ends such that the protruding movable contact portions may be moved into contact with the fixed contacts 13A, 13B and 14A, 14B, respectively.

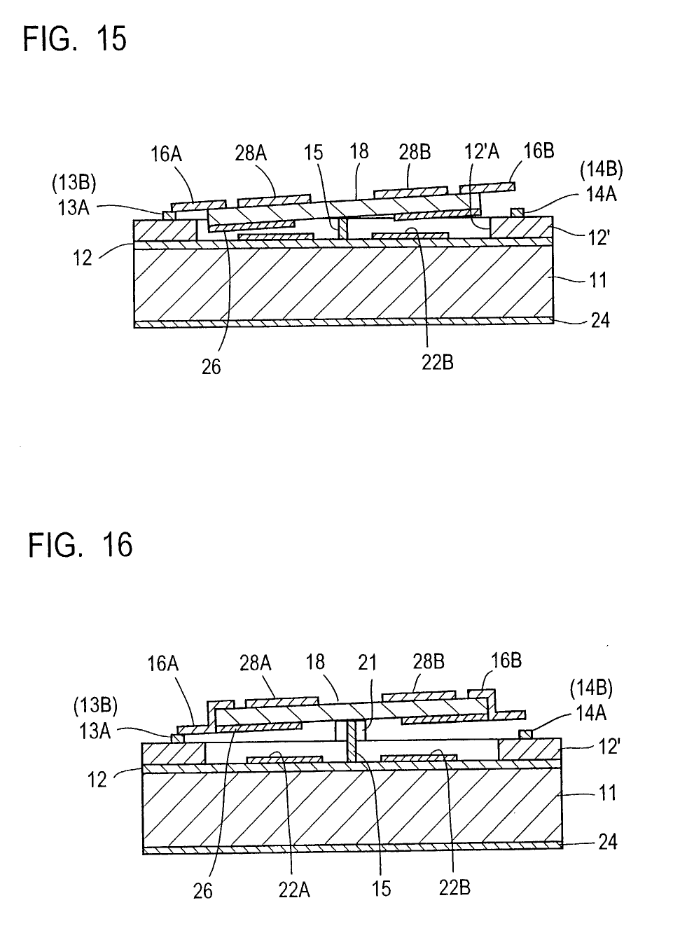

The movable contacts 16A and 16B are provided with flexibility by being extended from the ends of the movable plate 18. Due to this flexibility, it will be appreciated that as the movable contacts 16A and 16B are moved into contact with the fixed contacts 13A, 13B and 14A, 14B, respectively, they are elastically deformed prior to contacting the fixed contacts, resulting in more or less sliding or wiping movements of the movable contacts along the fixed contacts. It is thus to be understood that these embodiments are directed to the arrangement designed with the expectation that such sliding movement will provide so-called self-cleaning action. The fifth embodiment of FIG. 15 illustrates the construction in which the movable contacts are protruded rectilinearly from the upper surface of the movable plate 18 while the sixth embodiment of FIG. 16 illustrates the construction in which the movable contacts extend from the upper surface of the movable plate 18 and then around the end face thereof before they protrude from the lower surface of the plate.

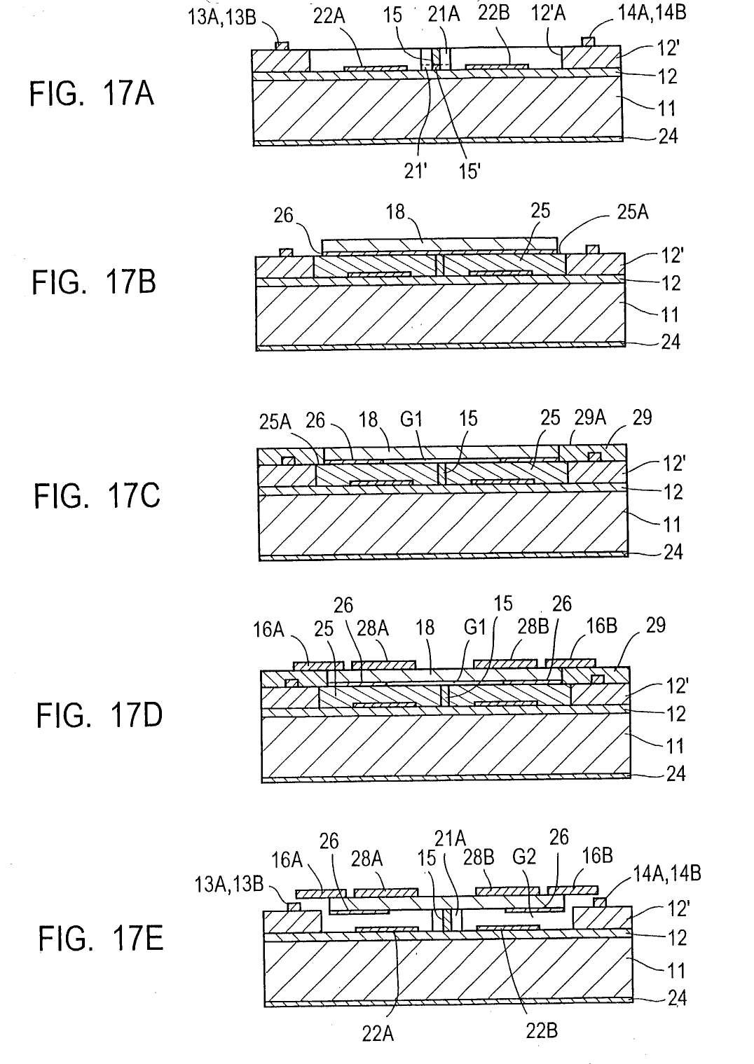

Now referring to FIG. 17, a method of producing the integrated type microswitch of the construction illustrated in FIG. 15 will be described. An additional insulation layer 12′ composed of SiO₂ for example is formed on the semiconductor substrate 11 that has been coated with an insulation layer 12 comprising SiN for example, followed by forming fixed contacts 13A, 13B and 14A, 14B on the insulation layer 12′ and forming recesses 12′A in the insulation layer 12′ to expose the insulation layer 12 at the bottoms of the recesses 12′A. Lower electrodes 22A, 22B, a base 15′ for the fulcrum means, and bases 21′ for support plates 21A on the exposed surfaces of the insulation layer 12. Further, a fulcrum means 15 and support plates 21A are formed to a predetermined height on the base 15′ and the bases 21′, respectively as by Ni-plating (FIG. 17A).

Next, a layer 25 of resin such as polyimide is formed by application on the exposed surfaces of the insulation layer 12 to provide a flat surface. The resin layer 25 is then etched back to an extent that the top surface of the fulcrum means 15 is exposed, to thereby form a flat surface 25A flush with the insulation layer 12′. Then, an insulation layer 26 of poly-Si, for example which may be easily etched is formed on the resin layer 25 which will be a first sacrificial layer and the insulation layer 12′. An insulating multi-layer film is formed by depositing SiN, SiO₂ and SiN sequentially in the order named by sputtering on the insulation layer 26. Then, a photoresist pattern is laid over the insulating multi-layer film as a mask, followed by forming the movable plate 18, the position-maintaining means 19 and the electrode sections 21 by dry etching. This laminated structure suffers reduced warping due to balanced stresses to allow for providing a movable plate 18 of increased strength. It is to be noted that a number of the through-apertures 18A as shown in FIG. 4 are also formed through the movable plate 18 by this dry etching (FIG. 17B).

Next, the flat surface 25A and the surface of the movable plate 18 are coated with a masking film to form a masking pattern, and only those portions of the insulation layer 26 underlying the central portion of the movable plate 18 and the position-maintaining means 19 (not shown in FIG. 17) which have not been covered with the masking pattern etched off through the through-apertures 18A (see FIG. 4) to define a gap G1 between the movable plate 18 and the fulcrum means 15, which are thus separated from each other by the gap G1. After that, the masking film is removed, and a resin such as photoresist is applied on the surface 25A to provide a resin layer 29 which will be a second sacrificial layer. The resin layer 29 is then etched back until the top surface of the fulcrum means 15 is exposed to form a flat surface 29A (FIG. 17C).

Metal materials are laminated in the sequence of Pd-Mo-Au on the surface 29A of the resin layer 29 flush with the movable plate 18. Then, only those portions of the resulting metallic multi-layer which will ultimately be the switching movable contacts 16A and 16B and the upper electrodes 28A, 28B are coated with Ni-plating. With this Ni-plating layer as a mask, those unnecessary portions of the metallic multi-layer are then removed by ion milling to form the movable contacts 16A and 16B and the upper electrodes 28A, 28B (FIG. 17D).

Next, the resin layers 25 and 29 are removed by etching to define a void space G2 between the movable plate 18 and the substrate 11 to complete the integrated type microswitch as shown in FIG. 15 (FIG. 17E).

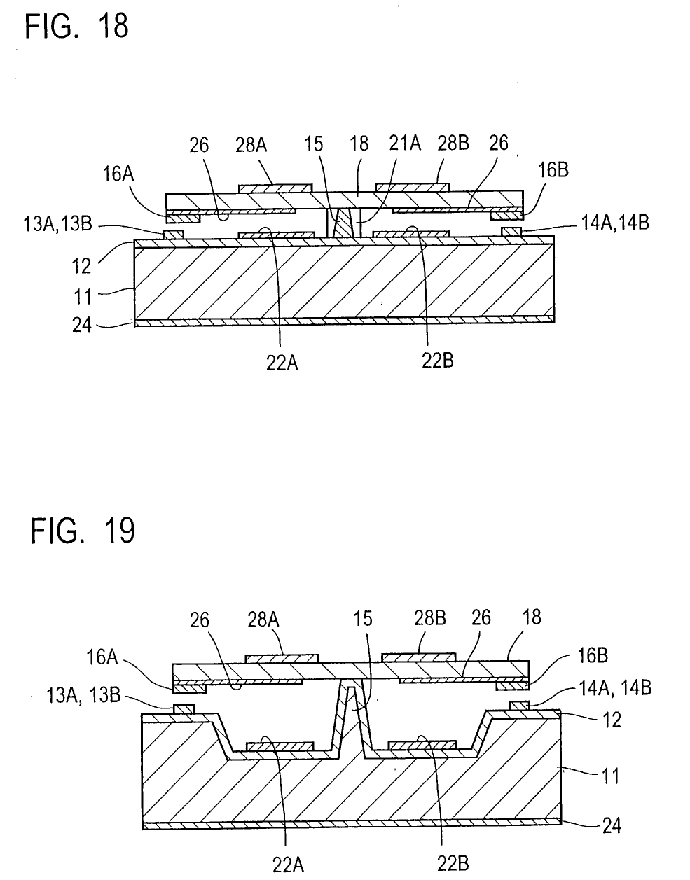

FIG. 18 illustrates a seventh embodiment which is a modified form of the embodiment shown in FIGS. 14-16. This embodiment shows the integrated type microswitch of the construction in which a fulcrum means 15, fixed contacts 13A, 13B and 14A, 14B, and lower electrodes 22A, 22B are formed on the flat surface of a substrate 11 with an insulation layer 12 interposed between the said elements and the substrate and in which a movable plate 18 has upper electrodes 28A, 28B and movable contacts 16A, 16B mounted thereon.

The movement of the movable plate 18 is effected by electrostatic driving force generated by voltage applied between the lower electrodes 22A, 22B and the upper electrodes 28A, 28B. The construction of this embodiment is characterized in that whether the substrate 11 may be made of conductor, semiconductor or insulator, it is possible to construct an integrated type microswitch. The fulcrum means 15 and the movable plate 18 are formed of insulator.

FIG. 19 illustrates an eighth embodiment in which a fulcrum means 15 is constructed by a substrate 11 itself. Specifically, in this case a semiconductor substrate such as Si or GaAs is employed as the substrate 11, which is subjected to etching process to form the fulcrum means 15, followed by forming an the insulation layer 12, on which fixed contacts 13A, 13B and 14A, 14B and lower electrodes 22A, 22B are formed. The structure of the movable plate 18 is the same as that shown in FIG. 18.

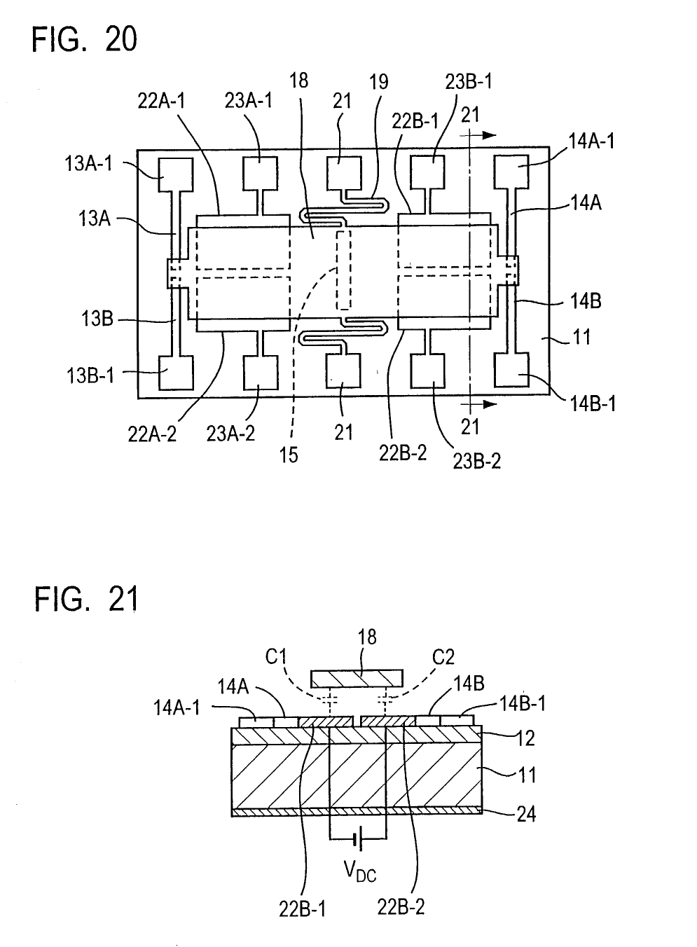

FIGS. 20 and 21 illustrate a ninth embodiment of the integrated type microswitch of this invention as set forth in claim 4 which is characterized by the structure of the drive means for driving the movable plate 18.

Specifically, it is characterized in that a plurality of lower electrodes 22A-1, 22A-2 and 22B-1, 22B are disposed on the substrate 11 on the opposite sides of the fulcrum means 15 in opposing relation to the corresponding opposite swing end portions of the movable plate 18, the arrangement being such that upon driving voltage being applied between the lower electrodes 22A-1 and 22A-2 corresponding to one of the opposite swing end portions of the movable plate 18, attraction force is exerted on the corresponding one swing end and upon such driving voltage being switched to the lower electrodes 22B-1 and 22B-2 corresponding to the other swing end, attraction force is exerted on the other swing end to thereby provide the seesaw movement.

The operation of imparting attraction force to the movable plate 18 will be described with reference to FIG. 21. This embodiment makes use of the technology of the electrostatic generator as disclosed in the thesis “Electrostatic Levitation” by T. Higuchi, Measuring and Controlling, Vol. 38, No. 2, February 1999, pp 101-104. It should be noted, however, that this publication deals with electrostatic levitation and transportation mechanism, but neither disclose nor even suggests the application of the technology to the drive means for effecting seesaw motion.

FIG. 21 is a cross-sectional view taken on line 21-21 of FIG. 20. It is seen that the movable plate 18 is positioned in opposition to the lower electrodes 22B-1 and 22B-2. Assuming that the movable plate 18 has conductivity, electrostatic capacitances C1 and C2 will be generated between the lower electrode 22B-1 and the movable plate 18 and between the lower electrode 22B-2 and the movable plate 18, respectively.

When DC driving voltage V_{DC} is applied between the lower electrodes 22B-1 and 22B-2, electric charge will be accumulated in both of the electrostatic capacitances C1 and C2, whereby the potential of the movable plate 18 is stabilized at a potential corresponding approximately to a median of the voltage V_{DC} applied between the lower electrodes 22B-1 and 22B-2.

Due to the electrostatic capacitances C1 and C2 being charged, electrostatic attraction forces occur between the lower electrode 22B-1 and the movable plate 18 and between the lower electrode 22B-2 and the movable plate 18, respectively.

It will be appreciated that when driving voltage is applied between the lower electrodes 22A-1 and 22A-2 corresponding to the opposite swing end, the absolutely same action as discussed above will occur.

It is thus to be understood that the movable plate 18 may be swung in a seesaw fashion by applying driving voltage V_{DC} alternately between the lower electrode pair 22A-1 and 22A-2 and between the lower electrode pair 22B-1 and 22B-2.

With regard to the material of which the movable plate 18 is made, it is to be noted that while it is described as being formed of conductive material in the foregoing example, there is no specific limitation to the material. Even the movable plate 18 which is constructed of insulating material may equally be seesawed. For particulars refer to the aforementioned publication “Measuring and Controlling” Volume 38, No. 2, February 1999, pp 101-104.

While in the embodiment shown in FIG. 20 one pair of lower electrodes 22A-1 and 22A-2 or 22B-1 and 22B-2 is illustrated as being provided for each of the opposite swing end portions of the movable plate 18, the number of the lower electrodes is not limited to one pair, but may be three or more. In that case, each pair of lower electrodes may be impressed with driving voltage and application of such driving voltage may be switched from one swing end to the other swing end to thereby seesaw the movable plate 18.

According to the embodiment shown in FIG. 20, there is no need for supplying voltage to the movable plate 18 in contrast to the embodiments shown in FIG. 1 or 6. Consequently, there is no need for providing the position-maintaining means 19 with electric wiring. It is thus to be appreciated that it provides the advantage of simplifying the manufacturing process as compared with the integrated type microswitch shown in FIG. 1 or 6. In addition, it provides another advantage that durability may be enhanced since no electric wiring is required of the hinges comprising the position-maintaining means 19.

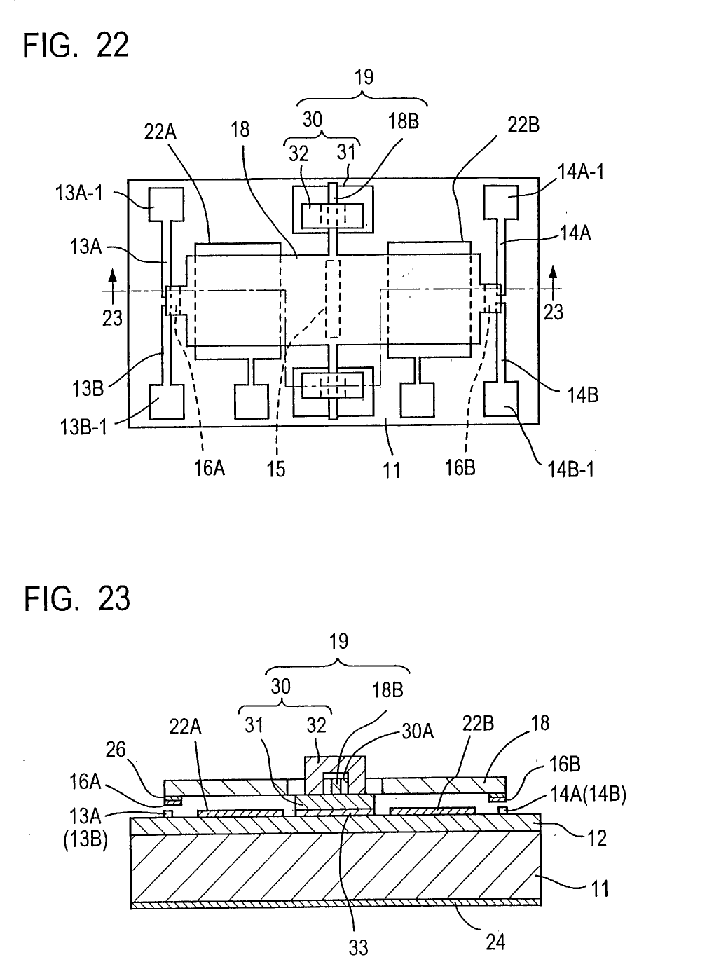

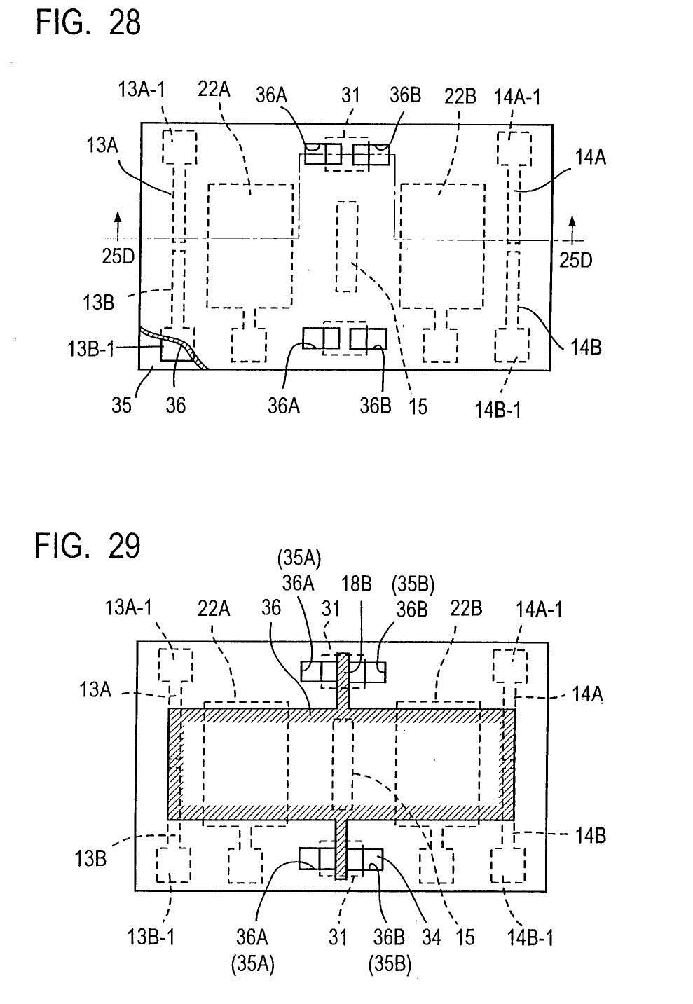

FIGS. 22 through 29 illustrate a tenth and eleventh embodiments of the integrated type microswitch of this invention as set forth in claim 11. The integrated type microswitch as set forth in claims 11 is characterized by the construction of the position-maintaining means 19 which comprises support shafts 18B integrally formed with the movable plate 18, and bearing means 30 mounted on the substrate 11 for receiving the support shafts 18B therethrough.

Each of the bearing means 30 comprises a support plate 31 raised from the planar surface of the substrate 11 and an arch 32 provided on the support plate 31 to define a hollow opening 30A surrounded by the support plate 31 and the arch 32 for receiving the support shaft 18B therethrough to maintain the movable plate 18 in position. While the methods of manufacturing the support shaft 18B, the support plate 31 and the arch 32 will be described hereinafter, in the tenth embodiment shown in FIG. 22 the support plate 31 and arch 32 are formed of conductive material and the movable plate 18 and the support shaft 18B are also made of conductive material.

It is thus to be understood that the movable plate 18 may be impressed with voltage through the support plates 31. The seesaw movement of the movable plate 18 may be effected by applying one pole of driving voltage to the movable plate 18 and impressing alternatively either one of the lower electrodes 22A and 22B with the other pole of the driving voltage.

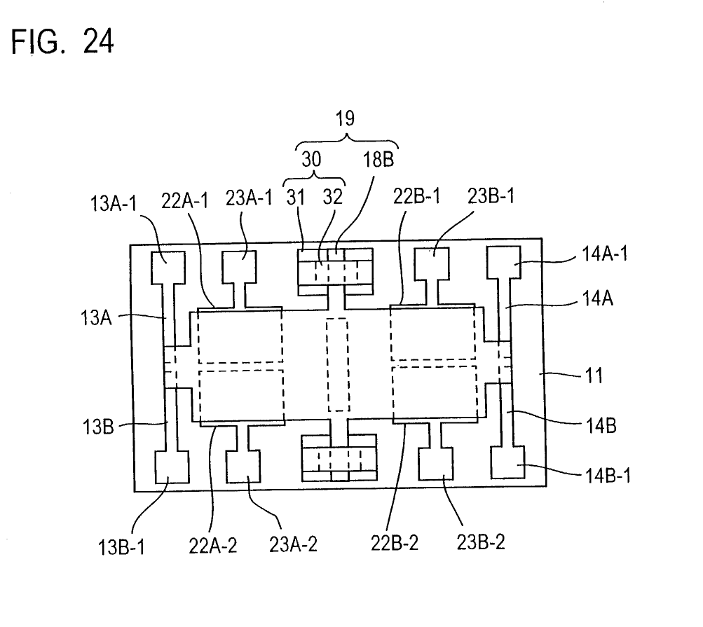

In the tenth embodiment illustrated in FIGS. 22 and 23, the movable plate 18 and the support shaft 18B are made of conductive material so that attraction force may be generated by applying electric field between the movable plate 18 and either the lower electrode 22A or 22B. In the eleventh embodiment illustrated in FIG. 24, however, one pair of lower electrodes 22A1, 22A-2 and another pair of lower electrodes 22B-1, 22B are disposed on the substrate 11 for one and the other, respectively of the opposite swing end portions of the movable plate 18, so that driving voltage may be applied alternatively between the lower electrodes 22A-1 and 22A-2 and between the lower electrodes 22B-1 and 22B-2 to move the movable plate 18 in a seesaw fashion, as in the ninth embodiment illustrated in FIG. 20.

It will be understood that the eleventh employment of the drive mechanism illustrated in FIG. 24 eliminates the need for applying voltage to the movable plate 18 and thus introduces the advantage that the movable plate 18 may be constructed of any desired suitable material including insulator and semiconductor, rather than necessarily metallic material.

According to the constructions of the embodiments illustrated in FIGS. 22-24, the movable plate 18 is supported for seesaw motion mainly by the fulcrum means 15 and further the support shafts 18B are supported against displacement in position by the bearing means 30, so that the movable plate 18 is subjected to no external counterforce and may therefore be seesawed by small attraction force. In addition, even while the movable contacts 16A and 16B are in contact with the fixed contacts 13A, 13B and 14A, 14B, they may be maintained in their stable contact state with no counterforce acting to separate the movable and fixed contacts from each other.

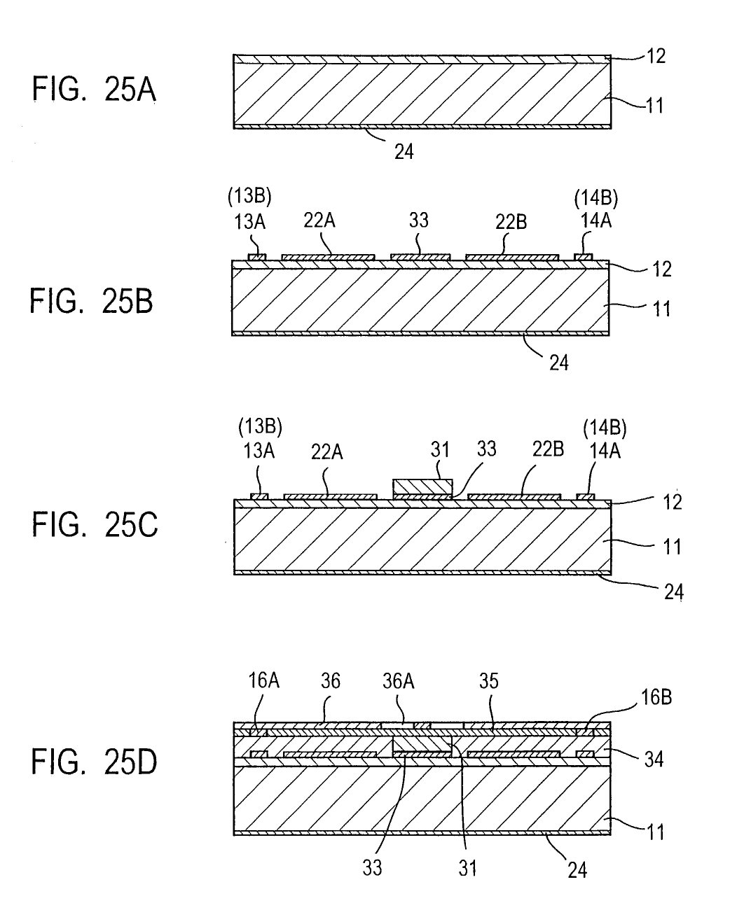

Referring to FIGS. 25-29, a method (claim 24) of producing the integrated type microswitch illustrated in FIGS. 22-24 will now be described. Here, the description of the method will be focused particularly on the support shafts 18B and the bearing means 30.

A substrate 11 made of silicon, for example is prepared, followed by forming a common potential layer 24 and an insulation layer 12 of SiO₂ on the back side and top side, respectively of the substrate 11 (FIG. 25A).

The next step is to deposit a metallic layer on the upper surface of the insulation layer 12 as by vapor deposition, followed by forming metallic layer sections 33 which will be bases for support plates 31 (see FIGS. 23 and 24) on those locations on the metallic layer where the support plates 31 are to be formed and forming lower electrodes 22A, 22B and fixed contacts 13A, 13B and 14A, 14B, as through etching process with the use of a photoresist mask (FIG. 25B). It is also to be noted that in FIG. 25B a metallic base section 15′ on which the fulcrum means 15 will be formed is also formed behind the metallic layer sections 33.

Then, the metallic layer is masked with a photoresist layer, for example in such a manner as to expose only the metallic layer sections 33 for the support plates and the metallic base section 15′ for the base of the fulcrum means 15, followed by forming on the metallic layer sections 33 and the metallic layer section 15′ metallic plating layers which will become the support plates 31 constituting the bearing means 30 and the fulcrum means 15 (FIG. 25C).

Next, a first sacrificial layer 34 of photoresist is formed to the same height as and is made flush with the support plates 31 and the fulcrum means 15. Then, a metallic layer is formed over the entire surface of this first sacrificial layer 34 as by vapor deposition, followed by etching the metallic layer to leave a predetermined pattern to thereby form the movable contacts 16A and 16B (FIG. 25).

Once the movable contacts 16A and 16B have been formed, a second sacrificial layer 35 of resinous material is formed on those surfaces of the first sacrificial layer 34 and the support plates 31 at areas where the movable contacts 16A and 16B are not present to the same height as these movable contacts so as to obtain a flat surface flush with the movable contacts, followed by forming a metal layer 36 on the entire flat surface. The upper surface of this metal layer 36 is then covered with a thick film of photoresist material to prepare a thick film photoresist pattern mask for the movable plate 18. Then, the rest of the metal layer 36 other than those for forming the movable plate 18 and the support shafts 18B are removed by ion milling, for example to shape the movable plate 18 and the support shafts 18B made of the metal layer 36. During this step, two apertures 36A, 36B are formed through the metal layer 36 at the locations opposing the two support plates 31, 31, respectively (see FIGS. 25, 26A and 28). These apertures are for forming arch posts. It should be noted that the unnecessary peripheral portions of the metal layer 36 are also removed so as to define the desired shapes of the movable plate 18 and the support shaft 18B.

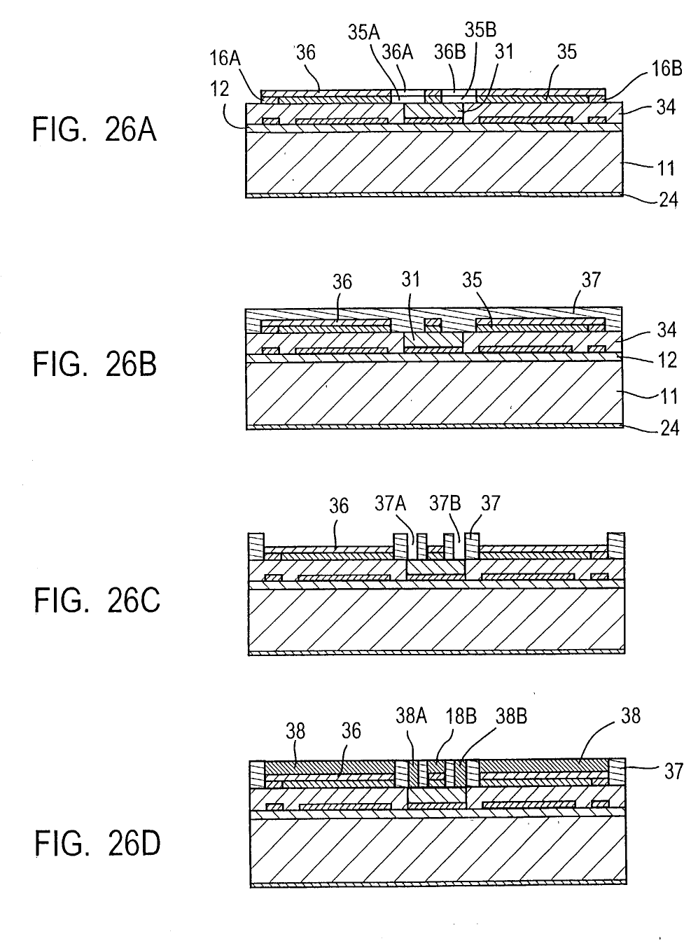

With the thus shaped metal layer 36 as a mask, apertures 35A, 35B are formed through the second sacrificial layer 35 as well. The unnecessary peripheral portions of the second sacrificial layer are likewise removed. It is thus to be understood that the support plates 31 and the first sacrificial layer 34 are exposed through the aligned apertures 36A, 35A and 36B, 35B (FIG. 26A).

Following the stage shown in FIG. 26A, a photoresist layer 37 is again deposited on the entire surface, that is, the surface of the metal layer 36, those surfaces of the first sacrificial layer 34 exposed through the apertures 36A, 35A and 36B, 35B, and those exposed surfaces of the first sacrificial layer 34 surrounding the outer periphery of the movable plate 18. This photoresist layer 37 is formed as a thick film having a thickness approximately equal to that of the movable plate 18 (FIG. 26B).

The photoresist layer 37 is then exposed to light in a pattern of the same shape as that of the metal layer 36 (shape of the movable plate 18 and the support shafts 18B) to remove those portions of the photoresist layer 37 overlying the metal layer 36. As a result, the metal layer 36 becomes exposed within the interior regions bounded by the photoresist layer 37 (FIG. 26C).

Next, the thus exposed upper surfaces of the metal layer 36 are coated with metal plating to form a plating layer 38 having a thickness approximately equal to that of the desired movable plate 18. The movable plate 18 and the support shafts 18B are thus constructed of this plating layer 38 and the metal layer 36. Further, during the exposure of the thick film photoresist layer 37, those portions of the photoresist film 37 which have filled the apertures 36A, 35A and 36B, 35B are preliminarily formed with through-apertures 37A, 37B communicating with the support plates 31, so that during the formation of the plating layer 38, arch posts 38A, 38B upstanding from the support plates 31 will be formed (FIG. 26D).

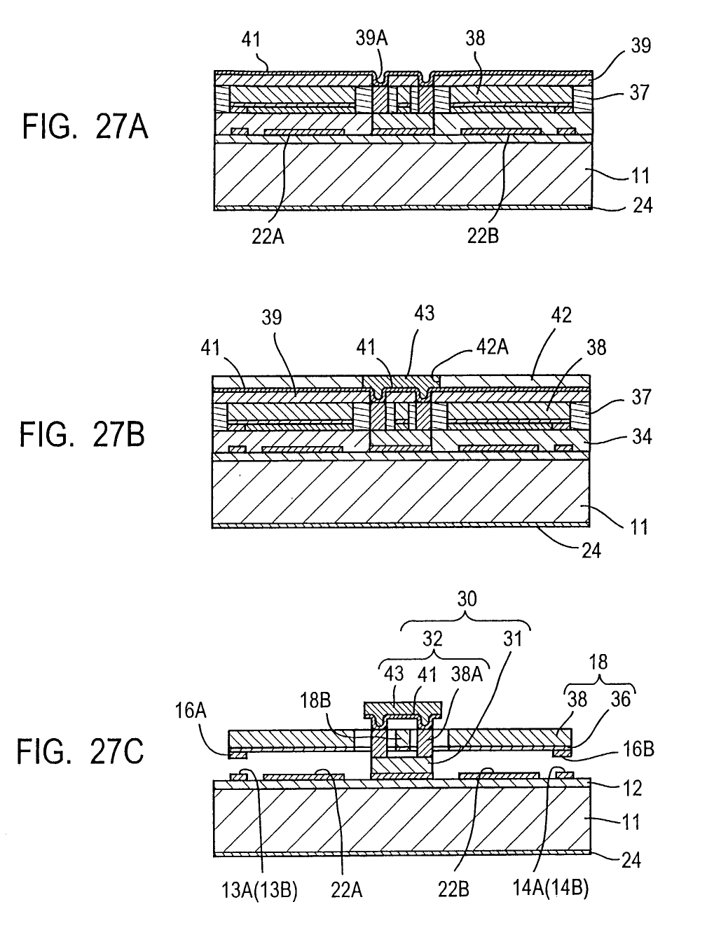

A third sacrificial layer 39 of photoresist is deposited again on the upper surfaces of the photoresist film 37 and the plating layer 38 to form a photo pattern mask which is in turn used to form apertures 39A, 39B communicating with the arch posts 38A, 38B in the third sacrificial layer 39, followed by forming a metal layer 41 as by vapor deposition on the upper surface of the third sacrificial layer 39 as well as the top surfaces of the arch posts 38A, 38B exposed within the apertures 39A, 39B (FIG. 27A).

Then, the upper surface of the metal layer 41 is coated with a fourth sacrificial layer 42 of photoresist, through which an elongated slot 42A spanning the apertures 39A and 39B is formed (FIG. 27B).

Formation of the elongated slot 42A exposes the metal layer 41 at the bottom of the elongated slot 42A. In this state, the upper surface of the metal layer 41 within the elongated slot 42A is plated with metal to form a metal plating layer 43 (FIG. 27B).

With the metal plating layer 43 formed on the metal layer 41, the fourth sacrificial layer 42 is removed while at the same time the metal layer 41 is removed by ion milling. When this is done, it will be understood that the plating layer 43 serves as a mask so that the portion of the metal layer 41 excluding the section which is covered with the plating layer 43 is removed. Further, the third sacrificial layer 39, the photoresist film 37, the second sacrificial layer 35 and the first sacrificial layer 34 are removed as by etching, whereby the movable plate 18, the support shafts 18B and the arches 32 are obtained as shown in FIG. 27C. Specifically, the movable plate 18 and the support shafts 18B are constructed of the plating layer 38 and the metal layer 36 while the arches 32 are composed of the posts 38A, 38B formed of the plating layer 38, and the metal layer 41 and the plating layer 43. It is further to be noted that the arch 32 and the associated support plate 31 are formed as an integral unit which constitutes a bearing means 30 with the corresponding support shaft 18B extending through the hollow opening defined by the arch 32.

As will be appreciated from the manufacturing method as described above, the dead weight of the movable plate 18 is supported mainly by the fulcrum means 15 and is prevented from displacement in position due to the support shafts 18B extending through the bearing means 30 as well as from dislodgement from the substrate 11.

Since the support plates 31, the support shafts 18B and the movable plate 18 are constructed mainly of a plating layer having conductivity, it is possible to seesaw the movable plate 18 by connecting one pole of driving voltage to the support plates 31 and the opposite pole of the driving voltage to either one of the lower electrodes 22A and 22B and alternatively switching the connection so that electrostatic attraction forces are generated between the movable plate 18 and either one or the other of the lower electrodes 22A and 22B.

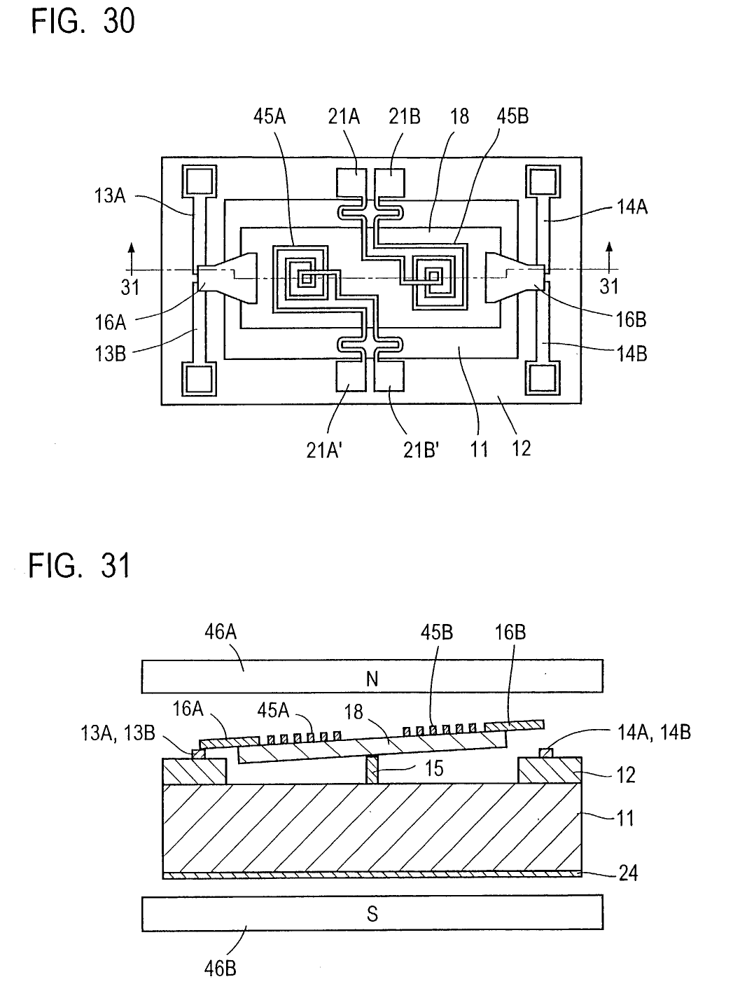

FIGS. 30 through 32 illustrate a twelfth embodiment of the integrated type microswitch of this invention as set forth in claim 5. The integrated type microswitch as set forth in claims 5 is characterized by the construction in which the movement of the movable plate 18 is effected by magnetic force generated through planar coils.

To this end, planar coils 45A and 45B are formed on the movable plate 18 at positions symmetrical about the pivot point thereof as shown in FIGS. 30 and 31. The arrangement is such that when exciting current is passed through either one of the planar coils 45A and 45B, repulsion (or attraction) force is generated in response to outer magnetic field established by permanent magnets 46A and 46B as shown in FIG. 31, whereby the movable contacts 16A and 16B are moved into and out of contact with the fixed contacts 13A, 13B, and 14A, 14B.

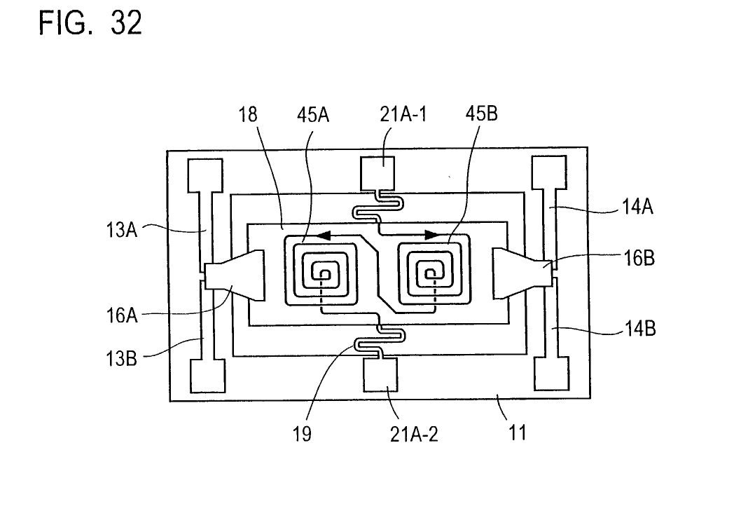

While the embodiment of FIG. 31 illustrates the arrangement in which exciting current is supplied separately to either one of the planar coils 45A and 45B, it is to be appreciated that as in the thirteenth embodiment shown in FIG. 32, the planar coils 45A and 45B may be wound in opposite directions and connected in series so that the pair of planar coils 45A and 45B will produce magnetic fields in opposite directions when they are supplied with exciting current from a pair of terminals 21A-1 and 21A-2. Accordingly, whenever one of the planar coils 45A and 45B produces a repulsion force or an attraction force against the permanent magnets 46A and 46B, the other of the planar coils will generate an attraction force or a repulsion force against the permanent magnets, so that they will provide a doubling of torque.

With this construction, the direction of pivoting of the movable plate 18 may be arbitrarily controlled between the forward and reverse directions by reversing the direction of passage of the electric current supplied from the terminals 21A-1 and 21A-2. It is thus to be appreciated that in the thirteenth embodiment shown in FIG. 32, the wiring for supplying current to the planar coils 45A and 45B need be provided only one for each of the opposite sides of the movable plate 18, hence requiring only one position-maintaining means 19 at each of the opposite sides, thereby leading to simplification in construction.

A well known multi-layer connecting technique is applied to the crossing points of the wound coils to prevent from short-circuiting.

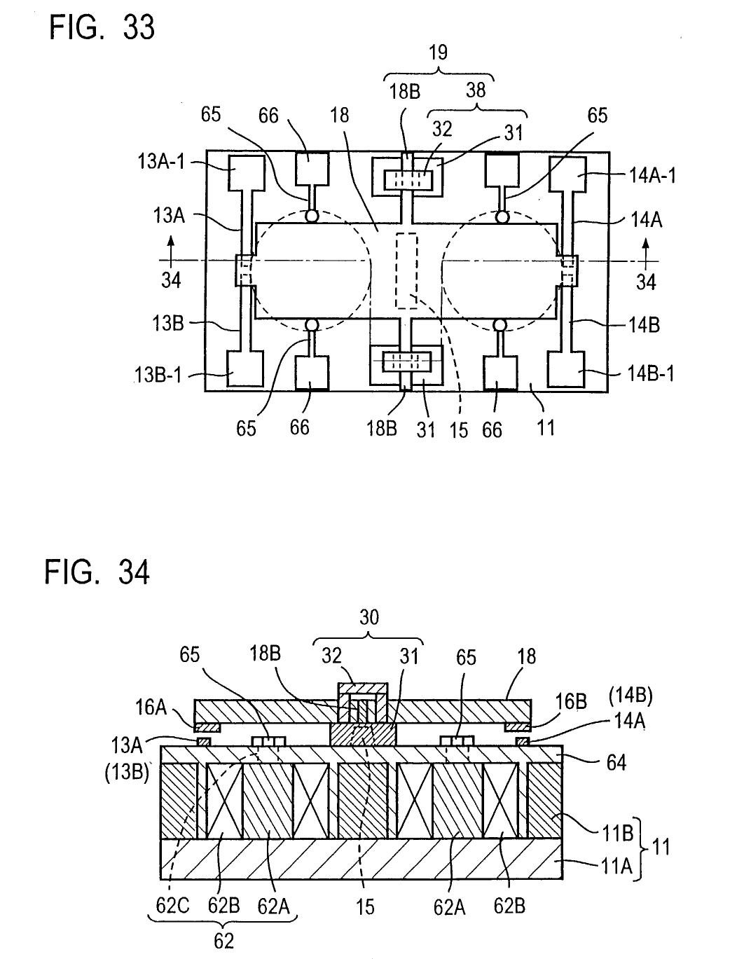

FIGS. 33 and 34 illustrate a fourteenth embodiment of the integrated type microswitch of this invention as set forth in claim 6. The integrated type microswitch shown in FIGS. 33 and 34 is a modified form of the planar-coil-driven integrated type microswitch shown in FIGS. 30-32.

The constructional feature of this embodiment is that individual exciting coils are independently made in the form of a tube or solenoid and are mounted and secured by resinous material in bores formed in a substrate. The surface of the substrate having the exciting coils or solenoids buried therein is then subjected to smoothing treatment, followed by forming fixed contacts on the smoothed surface and further forming and supporting the movable plate 18 for seesaw motion to complete a magnetically driven integrated type microswitch.

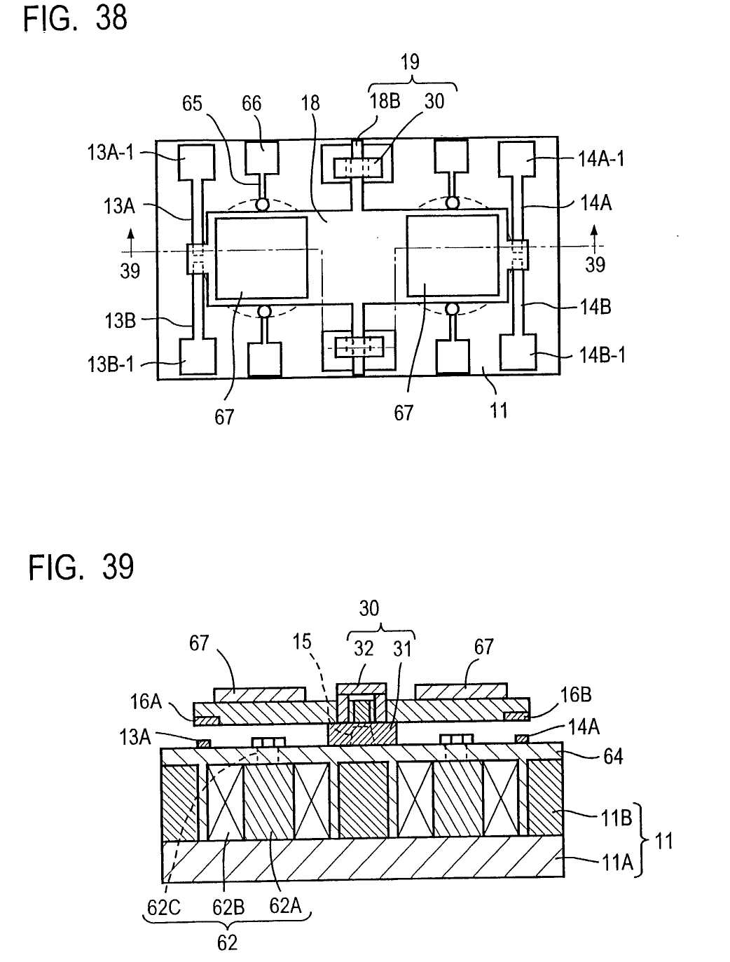

While the embodiment of FIGS. 33 and 34 illustrates an instance in which the movable plate 18 is formed of magnetic material, it is to be understood that a piece or pieces of magnetic material, preferably ferromagnetic material may be bonded to the movable plate 18 so as to produce magnetic attraction, as in the embodiment shown in FIGS. 38 and 39.

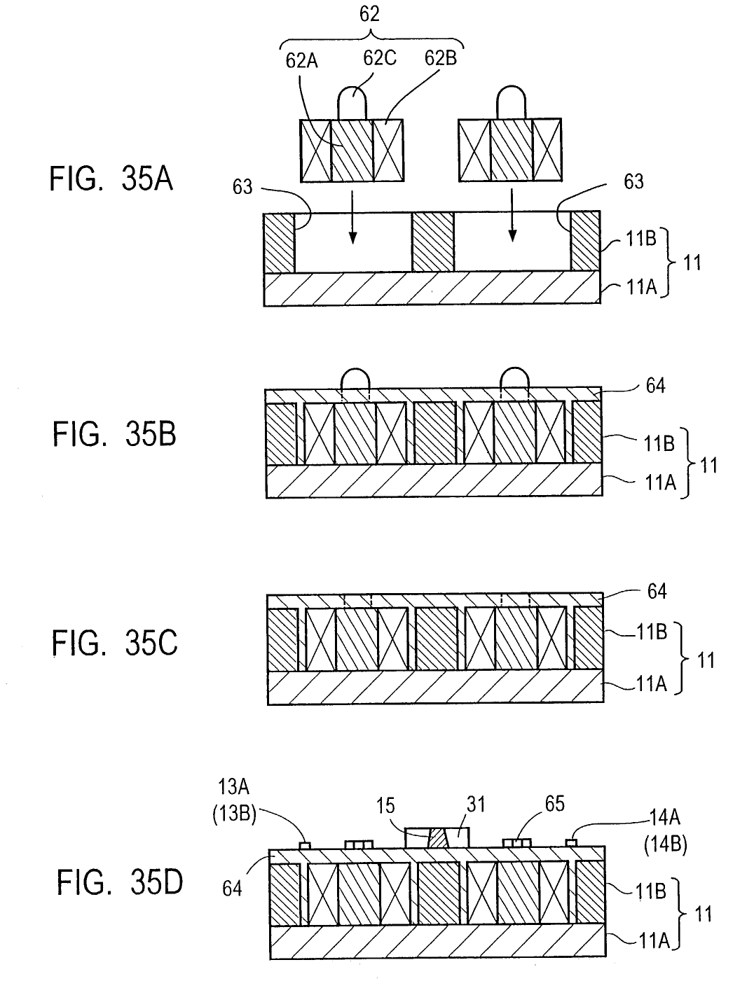

Referring to FIGS. 35-37, a method of producing the integrated type microswitch illustrated in FIGS. 33 and 34 will be described.

A supplemental substrate 11A is prepared as illustrated in FIG. 35A. The supplemental substrate 11A may be an insulation plate or conductor plate such as copper.

An intermediate board 11B is deposited on or bonded to one side of the supplemental substrate 11A to complete a substrate 11. The intermediate board 11B may also be an insulation plate or conductor plate. The supplemental substrate 11A need have only have a moderate mechanical strength and have no specific limitations in thickness imposed. However, the thickness of the intermediate board 11B is selected to be not less than the coil length (length of the magnetic core 62A) of the exciting coils 62 as will be described later. If the length of the magnetic core 62A is selected to be 0.6 mm, for instance, the intermediate board 11B is selected to have a thickness on the order of 0.7-0.8 mm.

A set of bores 63 are formed through the intermediate board 11B at predetermined spacings (determined depending on the length of the movable plate 18). While the drawings illustrate the steps of producing one integrated type microswitch, it should be understood that actually a multiplicity of sets of such bores 63 are formed in order to manufacture a lot of integrated type microswitches at one time. The bores 63 may be preliminarily formed through the intermediate board 11B before the intermediate board 11B having the bores 63 formed therethrough is bonded to the supplemental substrate 11A by adhesive.

Alternatively, the supplemental substrate 11A may be formed of copper, and a layer of copper may be deposited on one side of the copper-made supplemental substrate 11A to a thickness of 0.65-0.70 mm by plating process, for example to form an intermediate board 11B. In the case where the intermediate board 11B is formed by plating, bores 63 may be formed through the intermediate board 11B by photolithographic technology. The bores 63 are oversized in diameter to an extent that some gap is defined between the outer periphery of the exciting coil 62 and the inner wall of the bore 63.

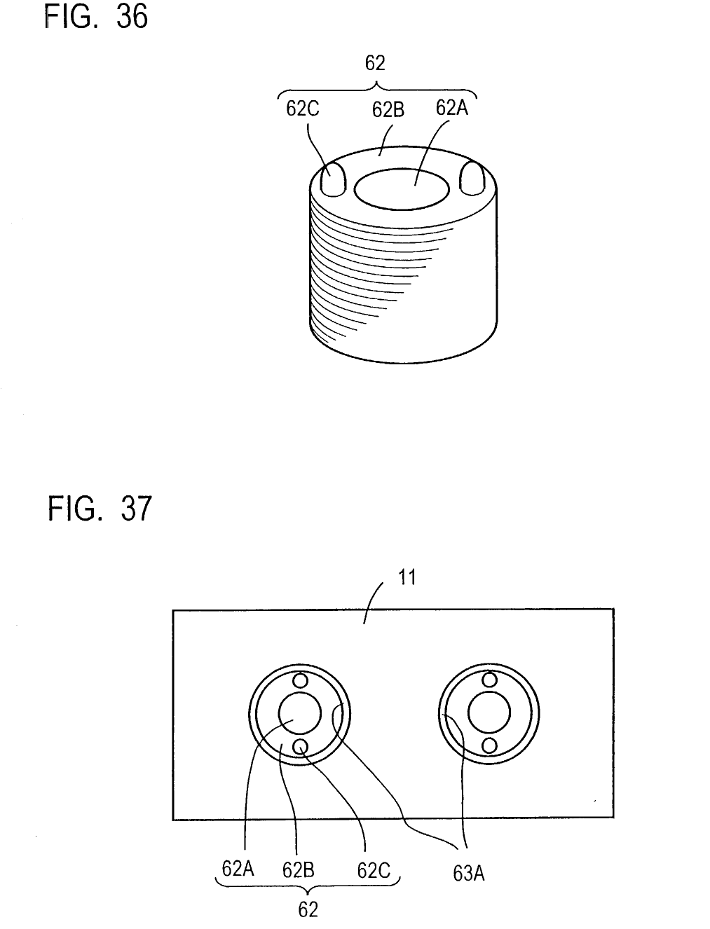

With the exciting coils 62 inserted in the corresponding bores 63, resinous material is poured into the bores 63 to fill them, particularly the gaps 63A (see FIGS. 35B and 37), and additionally the same resinous material is applied to the surface of the intermediate board 11B to form a resin layer 64 having a desired thickness (FIG. 35B).

Once the resin layer 64 has solidified, the projecting portions of the coil electrodes 62C and further the surface of the resin layer 64 are machined, followed by mirror finishing the surface of the resin layer (FIG. 35C).

The coil electrodes 62C are thus exposed and become flush with the mirror-finished surface of the resin layer 64. On this surface a metallic film is deposited, and then photolithographic technology is used to form wiring conductors 65 and electrodes 66 (FIG. 33) in contact with the coil electrodes 62C to thereby constitute a current supplying path to the exciting coils 62 while at the same time forming the fixed contacts 13A, 13B and 14A, 14B, and terminal sections 13A-1, 13B-1, 14A-1, 14B-1 as well as forming a base 15′ for the fulcrum means 15 and bases 21′ for support plates 31 of conductive layer.

The next step is to form a mask such as photoresist over these wiring conductors 65, electrodes 66, fixed contacts 13A, 13B, 14A, 14B, terminal sections 13A-1, 13B-1, 14A-1, 14B-1 as well as base sections 15′ and 21′ of the conductive layer and to provide openings through those portions of the mask in which the fulcrum means 15 and the support plates 31 are to be formed so as to expose the base sections 15′ and 21′ of the conductive layer sections in the openings, followed by forming a fulcrum means 15 and support plates 31 on those exposed base sections 15′ and 21′ of the conductive layer by plating (FIG. 35D).

Subsequent to forming the fulcrum means 15 and support plates 31, the same process as described above with reference to FIGS. 25A to 29 may be used to form a movable plate 18 and support shafts 18B for the movable plate 18, to form movable contacts 16A, 16B on the opposite swing end portions of the movable plate 18, and finally to form arches 32 over the support plates 31 to complete a magnetically-driven, integrated type microswitch as shown in FIGS. 38 and 39.

It should be noted here, however, that the process in this embodiment is different from that described above with reference to FIGS. 25A to 29 in that magnetic material is used as the material of which the movable plate 18 is composed. One example of suitable magnetic materials for the purpose of this invention is iron-nickel alloy.

With the construction of the magnetically-driven, integrated type microswitch as illustrated in FIGS. 38 and 39, applying exciting current to either one of the exciting coils 62 will generate a magnetic field which in turn acts to attract one of the swing free ends of the movable plate 18 toward the energized exciting coil 62 whereby either one of the movable contacts 16A and 16B brings either the fixed contacts 13A and 13B or the fixed contacts 14A and 14B into conduction.

The exciting coil 62, which is comprised of windings wound around a magnetic core 62A, produces a magnetic field of higher intensity as compared to the planar coil as shown in FIGS. 30 to 32. This introduces the advantage that the movable contact 16A or 16B may be contacted with the fixed contact 13A, 13B or the fixed contacts 14A, 14B with an increased contact force, thereby maintaining a stable state of contact.

FIGS. 38 and 39 illustrate a fifteenth embodiment of this invention in which the movable plate 18 is formed of a nonmagnetic material having magnetic attraction pieces 67 of magnetic material bonded thereon. It is thus to be appreciated that this construction in which the magnetic attraction pieces 67 are made separately from the movable plate 18 provides the advantage that it allows for the use of even such material that otherwise could not be formed as the movable plate 18 by sputtering process, and especially the use of material having a high magnetic permeability, whereby an integrated type microswitch having a strong magnetic attraction force may be obtained.

In addition, the contact pressure between the contacts may be further increased by preliminarily magnetizing the magnetic attraction pieces 67 with the opposite N-S polarities along the direction of their thickness. Specifically, a pair of magnetic attraction pieces 67 may be bonded on the movable plate 18 adjacent the opposite ends of its swing center with the N polarity sides of both of the pieces facing up. With this arrangement, the two magnetic attraction pieces 67 may be differentially energized to generate magnetic fields opposite in polarity to each other so that an attraction force is created at one of the swing end portions of the movable plate 18 while a repulsion force is generated at the other end. It will thus be appreciated that the attraction and repulsion forces are cooperative to provide about two-fold increase in contact pressure as compared to the embodiment illustrated in FIGS. 33 and 34.

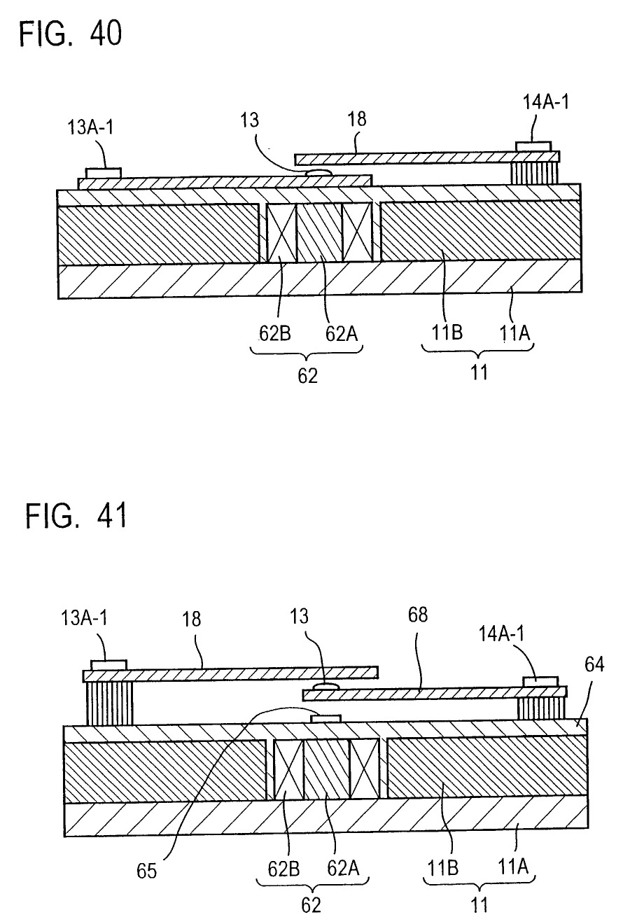

FIG. 40 illustrates a sixteenth embodiment of the integrated type microswitch of this invention as set forth in claim 18. This embodiment shows an instance in which a movable plate 18 is formed through micromachining technology so as to be supported in a cantilever fashion while an exciting coil 62 of construction as shown in FIG. 36 is embedded in a substrate 11 in opposing relation to the pivotable free end of the movable plate 18.

In this embodiment, the movable plate 18 is made of magnetic material having conductivity, the arrangement being such that electrical connection between the electrode sections 13A-1 and 14A-1 is established and ceased by moving the pivotable free end of the movable plate 18 into and out of contact with the fixed contact 13.

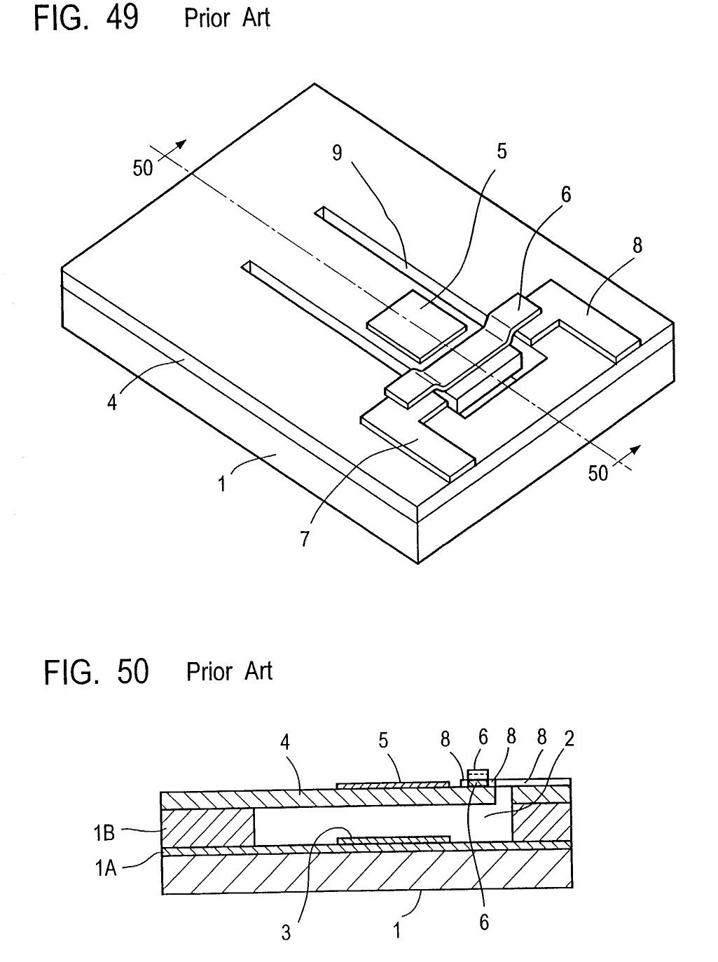

This embodiment is advantageously simple in construction, leading to enhanced manufacturability. The further advantage with this embodiment is again that the exciting coil 62, which is comprised of windings wound around a magnetic core 62A, creates a strong magnetic attraction force. This strong magnetic attraction provides a sufficiently great force to elastically bend the movable plate 18 of the cantilever construction even having a desired increased mechanical strength. Consequently, it will be appreciated that this construction overcomes the drawbacks to the prior art as discussed with reference to FIGS. 49 and 50.

FIG. 41 illustrates another embodiment of the integrated type microswitch of this invention as set forth in claim 19. This embodiment shows an instance in which a movable plate 18 is formed through micromachining technology so as to be supported in a cantilever fashion while a fixed contact 13 is carried on another cantilever member 68 so as to be contacted by the free end of the movable plate 18. In this case, the fixed contact supporting cantilever member 68 may be a conductor made of non-magnetic material. The arrangement is such that as the movable plate 18 is moved into contact with the fixed contact 13, the movable plate 18 presses on the fixed contact supporting member 68 to slightly bend the latter, whereby sliding movement is caused between the movable plate 18 and the fixed contact 13 to provide self-cleaning action between the contacts.

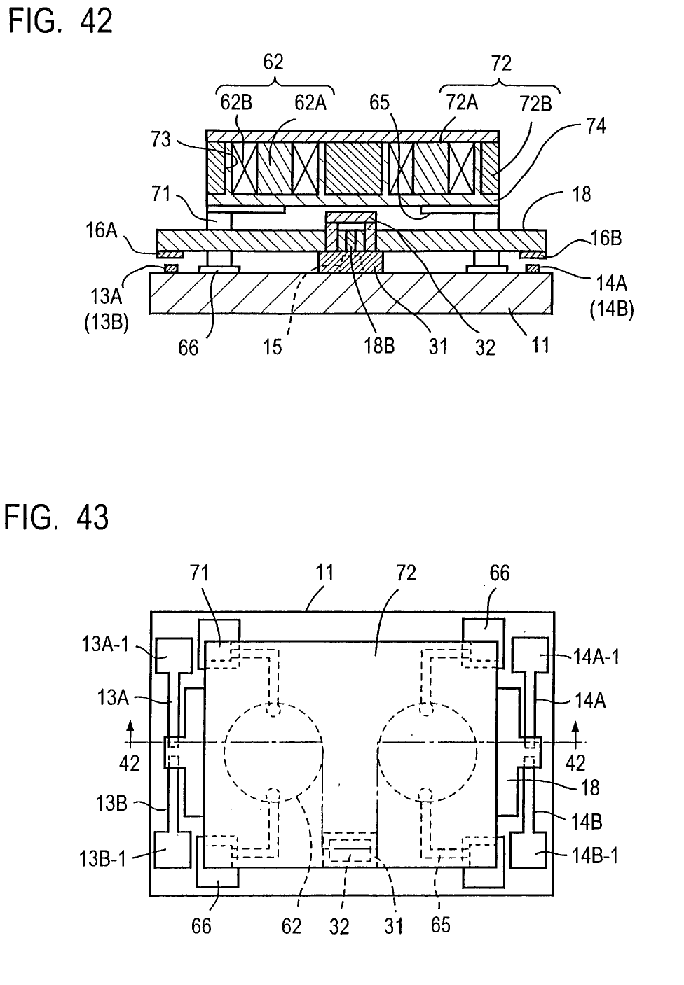

FIGS. 42 and 43 illustrate an eighteenth embodiment of the integrated type microswitch of this invention as set forth in claim 7. The integrated type microswitch as set forth in claim 7 shows an arrangement in which exciting coils 62 are located over the upper side of the movable plate 18.

On the substrate II there is formed an integrated type microswitch similar to that illustrated in FIGS. 22 and 23, except that the drive means for the movable plate is modified. Specifically, above the substrate 11 a second substrate 72 is supported by posts 71. Like the construction as described above with reference to FIGS. 33 and 34, for the benefit of increased strength the second substrate 72 is comprised of a supplemental substrate 72A and an intermediate board 72B for accommodating the exciting coils 62 therein. The intermediate board 72B is formed with bores 73 therethrough in which the exciting coils 62 are inserted. Subsequently, a resinous material is poured into the bores 73 to fill the gaps defined between the exciting coils 62 and the bores 73 to thereby the exciting coils 62 to the substrate 72. At the same time, a resinous material is also applied to the exposed surfaces of the exciting coils 62 and the intermediate board 72B to form a resin layer 74, which is then mirror finished, followed by forming wiring conductors 65 on the mirror finished surface of the resin layer 74 (FIG. 43).

The posts 71 are constructed of conductors to which the wiring conductors 65 are connected whereby the exciting circuits of the exciting coils 62 are electrically connected through the conductive posts 71 to the electrodes 66 disposed on the surface of the first substrate 11.

It is thus to be appreciated that the arrangement illustrated in FIGS. 42 and 43 in which the exciting coils 62 are located toward the upper side of the movable plate 18 provides for preparing separately the first substrate 11 provided with the movable plate 18 and the second substrate 72 provided with the exciting coils 62 and having preformed posts 71 protruding therefrom, whereby the two substrates may be easily assembled together to complete an integrated type microswitch. The easy fabrication is thereby realized.

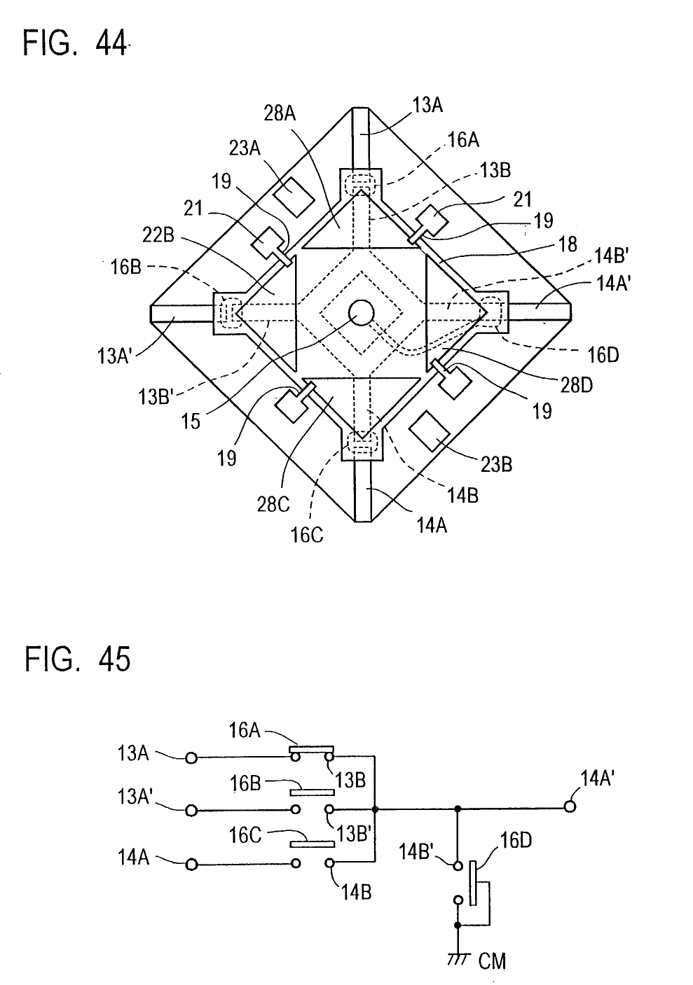

FIG. 44 illustrates a nineteenth embodiment of the integrated type microswitch of this invention as set forth in claim 20 which is a multi-contact gang switch.

This embodiment proposes a movable plate 18 of polygonal shape, for example, a regular quadrilateral shape is employed in the illustrated example. A fulcrum means 15 upstands from a substrate 11 at a location corresponding generally to the center of the movable plate 18. The movable plate 18 has position-maintaining means 19 extending therefrom generally in the center of each of the four sides of the movable plate 18. While the top end of the fulcrum means 15 is illustrated as being hemispherical, it is to be understood that it may take any configuration to allow seesaw motions of the movable plate 18 in four directions. Four triangular upper electrodes 28A, 28B, 28C, 28D are formed on the upper surface of the movable plate 18 one at each of the four corners thereof. Movable contacts 16A, 16B, 16C, 16D are formed on the undersurface of the movable plate 18 at the four corners thereof. The movable contacts 16A-16D are adapted to bring the corresponding pairs of fixed contacts 13A and 13B; 13A′ and 13B′; and 14A and 14B, selectively into and out of conduction. The fixed contacts 14A′ and 14B′ are directly connected already. It is thus to be understood that a signal input to one of the fixed contacts 13A, 13A′ and 14A by moving any one of the movable contacts 16A, 16B and 16C into contact with the corresponding fixed contacts 13A, 13B, 13A′, 13B′ and 14A, 14B may be taken out to the fixed contact 14A′. The movable contact 16D is electrically connected via a wiring conductor formed in the back side surface of the movable plate 18 to the fulcrum means 15 through which the contact 16D is connected to a common potential point CM.

It is further to be noted that in this embodiment, a conductor layer (not shown) having a surface area at least equal to that of the movable plate 18 is formed below that layer of the movable plate 18 in which the fixed contacts 13A, 13B, 13A′, 13B′, 14A, 14B, 14A′, 14B′ are formed on the substrate as a lower electrode. The movable plate 18 may be tilted in any desired direction by a force generated between the lower electrode and the upper electrodes 28A-28D when driving voltage is applied to the lower electrode through a terminal 23A or 23B.

With the construction of the integrated type microswitch illustrated in FIG. 44, a circuit structure as diagrammatically shown in FIG. 45 may be provided. Specifically, it is a circuit in which a signal input to any one of the fixed contacts 13A, 13A′ and 14A may be taken out to the fixed contact 14A′. It should also be noted that with all of the movable contacts 16A, 16B and 16C in their open positions, when the movable contact 16D is contacted with the fixed contact 14A′, the latter is connected through the movable contact 16D to the common potential point CM to prevent the signal leakage.

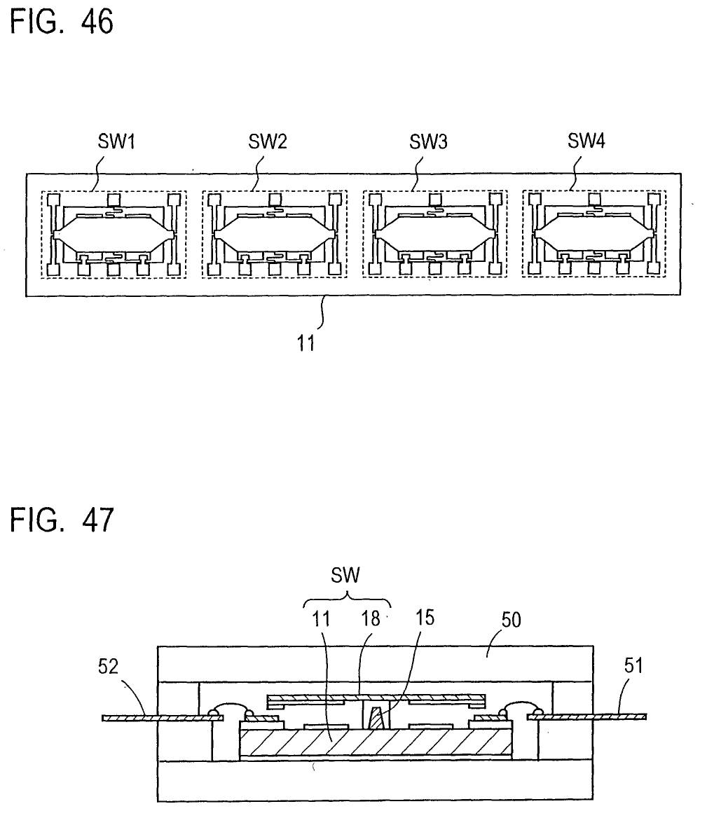

FIG. 46 illustrates a twentyth embodiment of the integrated type microswitch of this invention as set forth in claim 21 in which a plurality of integrated type microswitches SW1, SW2 . . . SW4 are formed on a common substrate 11. These individual switches are interconnected via wiring pattern to constitute a desired circuitry (not shown).

FIG. 47 illustrates a 21th embodiment of the integrated type microswitch of this invention as set forth in claim 22 showing the microswitch being actually mounted in a housing. That is, the integrated type microswitch SW comprising a substrate 11 and a movable plate 18 is housed in a sealed enclosure 50 having terminals 51, 52 leading out therefrom through which a switching signal is supplied for the on-off control of the switch. The gas-tight enclosure 50 may be filled with an antioxidant inert gas such as N₂ or Ar for practical use of the switch. Depending on the material of which the fixed contacts 13A, 13B, 14A, 14B and the movable contacts 16A, 16B are formed, it is also conceivable to use a mixture of N₂ and O₂.

While the lower electrodes 22A, 22B and the upper electrodes 28A, 28B are illustrated as being formed of metallic films in the various embodiments as described hereinabove, it can be understood that impurity-doped regions may be formed in the substrate and/or the movable plate for the purpose of utilizing such impurity-doped regions as the lower electrodes 22A, 22B and/or the upper electrodes 28A, 28B.

In addition, it is readily understood by those skilled in the art that the configuration of the hinge comprising the position-maintaining means 19 is not limited to any of the particular shapes illustrated in the embodiments described above.

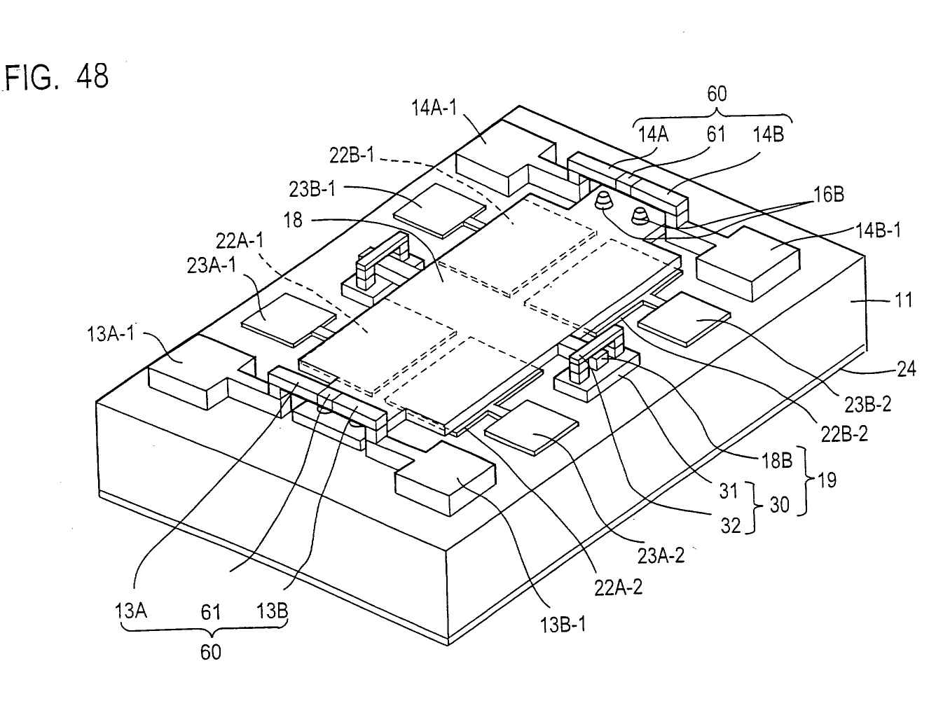

FIG. 48 illustrates a 22th embodiment of the integrated type microswitch of this invention as set forth in claim 14. This embodiment shows a modified form of the movable contacts 16A, 16B and the fixed contacts 13A, 13B, and 14A, 14B. Specifically, in this embodiment two pairs of movable contacts 16A, 16A and 16B, 16B are formed so as to extend upwardly from the opposite swing end portions of the movable plate 18 and are adapted to be moved into and out of contact with the fixed contacts 13A, 13B and 14A, 14B, respectively which are formed on respective beams 60 spaced upwardly from the top surface of the substrate 11.

The movable contacts 16A and 16B are generally conical, but have flat or rounded top surfaces so shaped as to prevent damage to the fixed contacts 13A, 13B and 14A, 14B contacted by the movable contacts. In the embodiment illustrated in FIG. 48, the movable contacts 16A, 16B are formed directly on the movable plate 18 which is made of conductive material so that the conductivity of the movable plate 18 may be utilized to electrically connect and disconnect the fixed contacts 13A and 13B and the fixed contacts 14A and 14B, respectively. It is to be noted that if it is required that the movable contacts 16A, 16B be electrically insulated from the movable plate 18, a metallic layer may be formed on the movable plate with an insulation layer sandwiched between the metallic layer and the movable plate. Then, two pairs of movable contacts 16A, 16A and 16B, 16B may be formed on the metallic layer such that there is electrical continuity between each pair of movable contacts.

In the case where the movable plate 18 is made of insulation material, a metallic layer may be formed directly on the movable plate 18. On this metallic layer, two pairs of movable contacts 16A, 16A and 16B, 16B may be formed such that there is electrical continuity between each pair of movable contacts.

The fixed contacts 13A, 13B, 14A, 14B, may be formed by plating, for example prior to the step of forming the beams 60.

The beams 60 may be formed by the fabricating process as described above with reference to FIGS. 25-29. The beams 60 are formed mainly of conductive material except for an intermediate insulator insert 61 dividing each of the beams in the middle into two electrically separated sections. One of the divided sections will be the fixed contact 13A, 14A, and the other will be fixed contact 13B, 14B.

These fixed contacts 13A, 13B and 14A, 14B are electrically connected to terminals 13A-1, 13B-1 and 14A-1, 14B1, respectively.

As discussed above, the construction in which the movable contacts 16A, 16B are formed on the upper side of the movable plate 18 provides the advantage of simplifying the manufacturing process as compared to the process for forming the movable contacts 16A, 16B on the back side of the movable plate 18.

Further, it should be noted that the embodiment shown in FIG. 48 is intended primarily to illustrate the construction in which the movable contacts 16A, 16B are formed on the upper side of the movable plate 18 and that it is not limited to a combination of the mechanism for supporting the movable plate 18 comprising the position-maintaining means 19 composed of the support shafts 18B and the bearing means 30 and the mechanism for seesawing the movable plate 18 comprising two pairs of lower electrodes 22A-1, 22A-2 and 22B-1, 22B-2 disposed in juxtaposition on the substrate 11, as illustrated in FIG. 48. In other words, it will be obvious to one skilled in the art that the construction of the movable contacts 16A, 16B is applicable to any of the constructions of the integrated type microswitch as described hereinabove.

Advantages of the Invention

As will be appreciated from the foregoing, the movable plate 18 according to this invention is formed through micromachining technology and configured to be moved in a seesaw movement to function electrically connection and disconnection between movable contacts and fixed contacts. The movable plate 18 itself is featured by not being subjected to elastic deformation. Because of this, the movable plate 18 is unlikely to encounter accidents of breakage, leading to advantage of providing a highly durable integrated type microswitch.

Another advantage is that when hinge means is employed as the position-maintaining means 19 for the movable plate 18, such hinge means is required to maintain only the position of the movable plate 18 since the weight of the movable plate 18 is supported mainly by the fulcrum means 15. Consequently, such a great strength necessary to support all of the weight of the movable plate 18 is actually not required of the hinge means, so that it may be so shaped as to be easily elastically deformed. Moreover, the construction according to this invention in which the movable plate 18 is moved in a seesaw motion about the fulcrum means 15 can minimize the spring force exerted by the hinge means and therefore allows for moving the movable plate 18 even with so weak a force as electrostatic force which has heretofore been unfeasible to be used as a switch driving power, and imparting a great contact pressure to the fixed contacts to ensure a stable contact state.

In addition, this invention has proposed the construction in which the position-maintaining means 19 for the movable plate 18 is composed of the support shafts 18B and the bearing means 30. This construction using the bearing means 30 produces virtually no counterforce against the seesaw movement of the movable plate 18 and hence provides for moving the movable plate 18 with further reduced attraction force in the case where the seesaw movement is effected by electrostatic force. The advantage that the movable plate 18 may be maintained in a stable contact position with the fixed contacts is also obtained. In this regard, the electromagnetically driven integrated type microswitch according to this invention provides an increased torque for driving the movable plate 18, resulting in a further stable contact state.

Especially, the construction using the exciting coils 62 as illustrated in FIGS. 33-43 allows for further increasing the attraction force to thereby introduce the remarkable advantage of even further stabilizing the contact state of the switch.

Furthermore, due to the fixed contacts 13A and 13B, and 14A and 14B being of an impedance-matched microstrip line construction, this invention advantageously makes it possible to transmit even high-frequency signals in a stable manner without deteriorating the waveform quality and therefore provides for on-off controlling high-frequency signals with reduced insertion loss and high separation ability.

Finally, this invention also provides the advantage that the integrated type microswitch according to this invention may be fabricated by the micromachining technology, and hence miniature-sized, high quality microswitches may be produced in quantity and yet inexpensively.

What is claimed is:

1. An integrated type microswitch comprising:
a substrate having fulcrum means upstanding from one surface thereof, said fulcrum means having a predetermined height and terminating in a top ridge portion;
a movable plate having an elongated shape and held on said substrate in such a manner that said movable plate positions above said fulcrum means at a center portion thereof so that opposite end portions of the movable plate on opposite sides of the fulcrum means is movable for a seesaw movement about the top ridge portion of said fulcrum means;
position-maintaining means for mounting said movable plate to said substrate in such a manner that the movable plate is maintained movable for the seesaw movement;
drive means for generating attraction force between the substrate and either one of the opposite end portions of the movable plate located on the opposite sides of the fulcrum means and alternately switching the generation of the attraction force between the opposite end portions to thereby seesaw the movable plate;
movable contacts mounted on the opposite end portions of the movable plate at opposite free ends thereof; and
fixed contacts attached to said substrate and adapted to be electrically connected to and disconnected from the movable contacts as the movable plate is moved in the seesaw movement.

2. The integrated type microswitch as set forth in claim 1, in which said drive means comprises two lower electrodes disposed on said substrate at opposed positions symmetrical about said fulcrum means, and the movable plate which is made of conductive material, the arrangement being such that a driving voltage is applied selectively and alternately between either one or the other of the lower electrodes and the movable plate and the movable plate.

3. The integrated type microswitch as set forth in claim 1, in which said drive means comprises two lower electrodes disposed on said substrate at opposed positions symmetrical about said fulcrum means, and two upper electrodes formed on the movable plate which is made of non-conductive material in opposite relation to the corresponding lower electrodes, the arrangement being such that a driving voltage is applied selectively and alternately between either one or the other of the lower electrodes and the opposing one of the upper electrodes.

4. The integrated type microswitch as set forth in claim 1, in which said drive means comprises a plurality of lower electrodes disposed on said substrate at each of opposed positions symmetrical about said fulcrum means, and said movable plate which is made of either conductive or non-conductive material, the arrangement being such that a driving voltage is applied selectively and alternately between the plurality of lower electrodes disposed at either one or the other of the opposed positions.

5. The integrated type microswitch as set forth in claim 1, in which said drive means comprises flat planar coils formed on said movable plate at opposed positions symmetrical about center pivot point thereof, and permanent magnet means adapted to generate a magnetic field parallel to magnetic fields generated by said planar coils, the arrangement being such that a driving voltage is applied selectively and alternately to either one or the other of the planar coils.

6. The integrated type microswitch as set forth in claim 1, in which said drive means comprises said movable plate which is formed of magnetic material, and two exciting coils wound in a tubular form and embedded in said substrate at opposed symmetrical positions about said fulcrum means, the arrangement being such that a driving voltage is applied selectively and alternately to either one or the other of the exciting coils.

7. The integrated type microswitch as set forth in claim 1, in which said drive means comprises said movable plate which is formed of magnetic material, and two exciting coils supported by a supplemental substrate at opposed symmetrical positions about said fulcrum means, said supplemental substrate being held to said substrate so as to be disposed above said movable plate, the arrangement being such that a driving voltage is applied selectively and alternately to either one or the other of the exciting coils.

8. The integrated type microswitch as set forth in claim 1, in which said drive means comprises a pair of magnetic attraction pieces of magnetic material mounted on said movable plate at opposed symmetrical positions about said fulcrum means, said movable plate being formed of magnetic material, and a pair of exciting coils embedded in said substrate in opposite relation to the corresponding magnetic attraction pieces, the arrangement being such that a driving voltage is applied selectively and alternately to either one or the other of the exciting coils at the opposed symmetrical positions.

9. The integrated type microswitch as set forth in claim 1, in which said drive means comprises a pair of magnetic attraction pieces mounted on said movable plate formed of non-magnetic material at opposed symmetrical positions about said fulcrum means, said magnetic attraction pieces having same magnetized polarity along the direction of their thickness, and a pair of exciting coils embedded in said substrate in opposite relation to the corresponding magnetic attraction pieces, the arrangement being such that the pair of exciting coils generate magnetic fields in opposite polarities to each other and said fields are switched in reverse direction.

10. The integrated type microswitch as set forth in claim 1, in which said position-maintaining means comprises a pair of elastically deformable hinge means integrally formed with said movable plate and outwardly extending from opposite longitudinal sides at center pivot points thereof, and a pair of support plates upstanding on said substrate at a pair of locations adjacent to opposite longitudinal sides of said movable plate at center pivot points thereof, free end of each of said hinge means having electrode section connected to corresponding support plate.

11. The integrated type microswitch as set forth in claim 1, in which said position-maintaining means comprises a pair of support shafts integrally formed with said movable plate and outwardly extending from opposite longitudinal sides at center pivot points thereof, and a pair of support plates upstanding on said substrate at a pair of locations adjacent to opposite longitudinal sides of said movable plate at the center pivot points thereof, said support plates having bearing bores for receiving the corresponding support shafts therethrough.

12. The integrated type microswitch as set forth in claim 1, in which said movable contacts are formed on an underside of said movable plate at free ends thereof while said fixed contacts are formed on the substrate at positions opposing said corresponding movable contacts, the predetermined height of said fulcrum means upstanding on said substrate is higher than upper surfaces of said fixed contacts.

13. The integrated type microswitch as set forth in claim 1, in which said movable contacts comprise resilient metallic portions secured to said movable member and extending oppositely outwardly from free ends of said movable plate in its elongated direction, said resilient metallic portions serving to provide self-cleaning action between said movable contacts and said fixed contacts.

14. The integrated type microswitch as set forth in claim 1, in which there are provided a pair of beams mounted on said substrate at an upwardly elevated location above respective end portions of the movable plate, said movable contacts are formed on upper side of said movable plate adjacent free ends of opposite end portions thereof while said fixed contacts are attached in face-down manner to the respective beams in opposite relation to said corresponding movable contacts.

15. The integrated type microswitch as set forth in claim 1, in which said fixed contacts are formed by conductors constituting signal transmission lines matched at a predetermined impedance.

16. The integrated type microswitch as set forth in claim 1, in which said fixed contacts are formed by conductors constituting microstrip lines.

17. The integrated type microswitch as set forth in claim 1, in which said fixed contacts are formed by conductors constituting coplanar microstrip lines.

18. An integrated type microswitch comprising:
fixed contacts formed on a substrate;
a cantilever made of a magnetic conductor and fixed at one end thereof to the substrate, said cantilever having the other end free to be movable to come near and away in opposite relation to a fixed contact; and
an exciting coil disposed in opposite relation to the free end of the cantilever, the coil being composed of wire wound in a tubular form.

19. An integrated type microswitch comprising:
a movable cantilever made of a magnetic conductor and fixed at one end thereof to a substrate;
a fixed-contact supporting cantilever made of a nonmagnetic conductor, supporting thereon a fixed contact at a position in opposite relation to, but slightly spaced from the free end of the movable cantilever; and
an exciting coil disposed in opposite relation to the free end of the movable cantilever, the coil being composed of wire wound in the form of a tube.

20. The integrated type microswitch as set forth in claim 1, in which said movable plate is of polygonal shape and is made of non-magnetic material, said fulcrum means is located below a center of said movable plate, said position-maintaining means supports said polygonal movable plate in such a manner as to allow each apex of the polygonal movable plate to be seesawed about said fulcrum means, has said movable contacts are mounted on said polygonal movable plate at respective apices thereof, said fixed contacts are formed on said substrate each in opposite relation to the corresponding one of said movable contacts, said drive means is adapted to drive said polygonal movable plate so as to attract selectively one of the apices of the movable plate whereby only the movable contact corresponding to the selected one of the apices and the associated fixed contact are brought into contact with each other while the movable contacts corresponding to the other apices and the associated fixed contacts are out of contact with each other.

21. An integrated type microswitch assembly in which a plurality of integrated type microswitches as set forth in claim 1 are formed in common on said substrate.

22. The integrated type microswitch as set forth in claim 1, in which said integrated type microswitch is housed in a sealed enclosure, said sealed enclosure being filled with inert gas.

23. A method of producing an integrated type microswitch, comprising the steps of:
forming a pair of lower electrodes and fixed contacts on one surface of a substrate;
forming a fulcrum means on said substrate in a space between said pair of opposing lower electrodes;
forming a sacrificial layer of a material which is removable by an etchant, said sacrificial layer having a thickness approximately equal to the height of the fulcrum means;
forming, on a surface of said sacrificial layer, movable contacts which are subsequently to be mounted on opposite free ends of a movable plate;
forming, on said sacrificial layer, an insulation layer which has a surface coplanar to the movable contacts;
forming, on said insulation layer, a layer of conductive material;
forming said movable plate and hinge means from said layer of conductive material, and forming apertures in said movable plate for the use of subsequent etching;
removing said insulation layer at a portion thereof formed between said fulcrum means and said movable plate through said etching apertures; and
removing said sacrificial layer by etching.

24. A method of producing an integrated type microswitch comprising the steps of:
forming a metallic layer on one surface of a substrate;
forming from said metallic layer a pair of lower electrodes, a base for fulcrum means, a base for support plates, and fixed contacts;
forming plating layers having a predetermined height on said base for the fulcrum means and said base for support plates to thereby form the fulcrum means and the support plates;
forming a first sacrificial layer having a thickness equal to the height of the fulcrum means and the support plates and having a flat surface coplanar to the surfaces of the fulcrum means and the support plates;
forming movable contacts on the surface of said first sacrificial layer at positions in opposite relation to said fixed contacts;
forming a second sacrificial layer on said first sacrificial layer so as to make the surface of said second sacrificial layer coplanar to the surfaces of the movable contacts;
forming a conductive layer on the surfaces of said second sacrificial layer and the movable contacts;
forming a pair of apertures through said conductive layer and said second sacrificial layer at each of the positions corresponding to said support plates for use of forming bearing means;
partially removing said conductive layer so as to leave such portions of the conductive layer as to shape said movable plate and a pair of support shafts integrally formed with and extending from the movable plate;
forming a photoresist layer approximately equal in thickness to that of the movable plate on those portions of-said second sacrificial layer from which said conductive layer has been removed;
forming a through-hole in the photoresist layer at each of portions thereof which are located in the pairs of the apertures of the conductive layer and the second sacrificial layer, so that said pair of support plates are exposed through said through-holes;
forming metal plating layers having a predetermined thickness on those surfaces of said conductive layer exposed in the area surrounded by said photoresist layer and on those surfaces of said support plates exposed through said through-holes to thereby form said movable plate, said support shafts and post portions of said bearing means;
forming a third sacrificial layer on a surface coplanar to surfaces of said photoresist layer, said movable plate, said support shafts and said post portions of the bearing means;
forming apertures through said third sacrificial layer so as to expose surfaces of said post portions of the bearing means;
forming a conductive layer in the interior of said apertures and on the entire surface of said third sacrificial layer;
forming a fourth sacrificial layer on this conductive layer;
forming elongated slots spanning said post portions of the bearing means in said fourth sacrificial layer;
forming plating layers having a predetermined thickness on those surfaces of the conductive layer exposed in said elongated slots to obtain a bridge portion of said bearing means which bridges between post portions thereof to thereby complete forming the bearing means; and
removing, subsequent to completion of said bearing means, said fourth sacrificial layer; said conductive layer exposed by the removal of said fourth sacrificial layer; the photoresist layer which has been left so as to surround said movable plate, said support shafts and said post portions of the bearing means by the removal of said conductive layer; and the second sacrificial layer and the first sacrificial layer formed between the movable plate and the substrate.

25. A method of producing an integrated type microswitch, comprising the steps of:
forming on a substrate a pair of lower electrodes, a base for fulcrum means, and a pair of bases for support plates;
forming on the substrate an insulation layer which has a recess to expose a part of the substrate where said lower electrodes, and the bases are formed;
forming fixed contacts on said insulation layer;
forming a fulcrum means and a pair of support plates having respectively a height approximately equal to that of the recess on the respective bases therefor;
forming in said recess a first sacrificial layer so that a flat surface coplanar to top surfaces of the fulcrum means, the support plates, the first sacrificial layer and the insulation layer is obtained;
forming, on said flat surface, a layer of an insulation material which is removable by an etchant and laminated layers of insulation materials thereon;
forming the movable plate by etching the layers of the insulation material and the laminated layers of the insulation materials, said movable plate being integrally formed with a pair of hinges extended outwardly from opposite elongated sides of the movable plate at center portion thereof, and located on the first sacrificial layer and having multiplicity of through-holes to expose the first sacrificial layer thereunder, and a pair of electrode sections being integrally connected with end terminals of the pair of hinges and located on the support plates;
removing by the etchant said layer of the insulation material formed between said first sacrificial layer and the movable plate only at a portion thereof below a center portion of the movable plate to thereby form a gap between said fulcrum means and the movable plate;
forming a second sacrificial layer approximately equal in thickness to that of the movable plate on said insulation layer on which said fixed contacts have been formed as well as on the first sacrificial layer so that a second flat surface coplanar to top surfaces of the movable plate and the second sacrificial layer is obtained;
forming a metal conductor layer all over the second flat surface;
etching said metal conductor layer to thereby obtain a pair of upper electrodes on said movable plate at locations symmetrical about the fulcrum means, wiring conductor portions on said hinges and the electrode sections connected to said upper electrodes, and movable contacts spanning from respective end portions of said movable plate to said second sacrificial layer; and
removing said first sacrificial layer and said second sacrificial layer to thereby form a second gap between said movable plate and said substrate.

26. A method of producing an integrated type microswitch, comprising the step of:
forming a fulcrum means having a certain height on a substrate;
forming a pair of fixed contacts on the substrate at locations symmetrical about the fulcrum means, said fixed contact having a height lower than that of the fulcrum means;
forming, on the substrate, a sacrificial layer having a thickness approximately equal to the height of the fulcrum means and having a flat surface coplanar to top surface of the fulcrum means;
forming, on said sacrificial layer, a removable layer of a material which is removable by an etching solution;
forming, on said removable layer, a movable plate, a pair of hinges connected with the movable plate, and a pair of electrode sections connected with the hinges of a non-conductive material;
forming a second sacrificial layer having a thickness approximately equal to that of the the movable plate on said removable layer at locations where said fixed contacts have been formed and having a flat surface coplanar to top surface of the movable plate;
forming planar coils on said movable plate at locations symmetrical about the fulcrum means and wiring conductors connected with the planar coils for supplying a driving current to said pair of planar coils, respectively;
forming movable contacts spanning opposite free ends of said movable plate and said second sacrificial layer;
removing said removable layer to separate said movable plate from said fulcrum means; and
removing said first and second sacrificial layers to separate said movable plate from the substrate.

27. A method of producing an integrated type microswitch, comprising the steps of:
forming a pair of bores in one surface of a substrate;
mounting exciting coils in said bores, each said coil being wound in a tubular form with electrodes connected to opposite ends of the coil such that the electrodes are located on one end face of said coil of the tubular form;
applying a resinous material on upper surface of said exciting coil and on upper surface of said substrate to form a layer of resin, followed by solidifying said resinous material to thereby secure said exciting coils in said bores;
machining upper surface of said resin layer and the electrode mounted on said exciting coil, followed by mirror-finishing the surface of said resin layer;
forming metal layers, on said mirror-finished surface of said resin layer, wiring conductors connected with the electrodes of said exciting coils, electrodes for applying a driving current to said wiring conductors, fixed contacts, a conductor base for a fulcrum means, and a pair of conductor bases for support plates;
forming first plating layers having a predetermined thickness on said base for the fulcrum means and said bases for the support plates to thereby form the fulcrum means and a pair of the support plates;
forming a first sacrificial layer having a thickness equal to that of the fulcrum means and the support plates so as to a flat surface thereof in which upper surfaces of the fulcrum means and the support plates are exposed;
forming movable contacts on the surface of said first sacrificial layer at positions in opposite relation to said fixed contacts;
forming a second sacrificial layer on said first sacrificial layer so as to make the surface of said first sacrificial layer flush with the surfaces of the movable contacts;
forming a first conductive layer on said second sacrificial layer and the movable contacts;
forming a pair of apertures through both said conductive layer and said second sacrificial layer to expose each of surface portions of said support plates to form post portions of bearing means;
partially removing said conductive layer so as to leave such portions of the conductive layer as to shape said movable plate and a pair of support shafts extending from the movable plate;
forming by deposition a photoresist layer approximately equal in thickness to the movable plate on those portions of said second sacrificial layer from which said conductive layer has been removed;
forming second plating layers having a predetermined thickness on those surface portions of said conductive layer exposed in the area surrounded by said photoresist layer and on those surface portions of said support plates exposed through said apertures to thereby form said movable plate, said support shafts and said post portions of said bearing means;
forming a third sacrificial layer on planar surfaces defined by the surfaces of said photoresist layer, said movable plate, said support shafts and said post portions of the bearing means;
forming apertures through said third sacrificial layer so as to expose upper surfaces of said post portions of the bearing means;
forming a second conductive layer in the interior of said apertures and on the surface of said third sacrificial layer;
forming a fourth sacrificial layer on this conductive layer;
forming elongated slots spanning said post portions of the bearing means in said fourth sacrificial layer;
forming third plating layers having a predetermined thickness on those surfaces of the second conductive layer exposed in said elongated slots to complete said bearing means; and
removing said fourth sacrificial layer;
removing said second conductive layer exposed by the removal of said fourth sacrificial layer;
removing the photoresist layer which has been left so as to surround said movable plate, said support shafts and said post portions of the bearing means by the removal of said second conductive layer; and
removing the second sacrificial layer and the first sacrificial layer formed between the movable plate and the substrate.

28. The integrated type microswitch as set forth in claim 1, in which said movable plate is formed initially in such a manner that a portion of undersurface of said movable plate and said top ridge portion of said fulcrum means are in contact with each other with a film layer having a minimal film thickness interposed therebetween, and remaining portion of the undersurface of said movable plate and said substrate are in contact with each other with a layer of resin interposed therebetween, said resin layer having a thickness approximately corresponding to the height of said fulcrum means, and said movable plate is ultimately held to said substrate by said position-maintaining means, while said film layer and said resin layer are removed.

29. The integrated type microswitch as set forth in claim 1, in which said movable plate is held by said position-maintaining means in such a state that the movable contacts and fixed contact are disconnected from each other while said drive means inactivates the movable plate.
